(19) United States
(12) Patent Application Publication
(10) Pub. No.: US 2025/0071717 A1
(43) Pub. Date: Feb. 27, 2025

(54) MACHINE LEARNING (ML)-BASED POSITIONING IN A WIRELESS COMMUNICATION SYSTEM THAT MITIGATES USER EQUIPMENT (UE) CLOCK DRIFT

(71) Applicant: QUALCOMM Incorporated, San Diego, CA (US)

(72) Inventors: Mohammed Ali Mohammed Hirzallah, San Diego, CA (US); Mohamad Sayed Hassan, Paris (FR); Srinivas Yerramalli, San Diego, CA (US)

(21) Appl. No.: 18/455,289

(22) Filed: Aug. 24, 2023

(51) Int. Cl. H04W 64/00; H04J 3/06; H04L 5/00

(52) U.S. Cl. CPC H04W 64/00; H04J 3/0661; H04L 5/0051

(57) ABSTRACT

This disclosure provides systems, methods, and devices for wireless communication that support machine learning (ML)-based positioning that mitigates user equipment (UE) clock drift. In some aspects, a UE may receive, from a network entity, positioning configuration that indicates positioning operations to be performed to gather training data to train an ML positioning model to account for UE clock drift. The UE may monitor for positioning reference signals from a transmit/receive point and transmit positioning measurements to a training entity. The positioning measurements may include multiple measurements at a fixed location, or the UE may augment the positioning measurements based on simulated clock drift measurements. Alternatively, the UE may transmit clock drift information with the positioning measurements to the training entity. Alternatively, the UE may utilize a hybrid approach that combines multiple positioning measurements with augmentation or providing clock drift information. Other aspects and features are also claimed and described.

### TECHNICAL FIELD

Aspects of the present disclosure relate generally to wireless communication systems, and more particularly, to machine learning (ML)-based positioning that mitigates user equipment (UE) clock drift. Some features may enable and provide improved communications, including wireless communication-based positioning with improved accuracy using trained ML or artificial intelligence positioning models.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks may be multiple access networks that support communications for multiple users by sharing the available network resources.

A wireless communication network may include several components. These components may include wireless communication devices, such as base stations (or node Bs) that may support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on a downlink to a UE or may receive data and control information on an uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

Wireless communication devices may perform a variety of positioning techniques to determine respective locations. Some such positioning techniques include timing-based positioning and angle-based positioning that often involve a communication exchange between a wireless communication device that is determining a respective location and a device that currently possesses location information. A user equipment (UE) that performs a positioning operation typically exchanges communications with another device and often compares timing of transmitted and received messages as part of the positioning operation. As such, a UE clock is an important tool in the performance of a positioning operation or process. Although most UE clocks are well-calibrated and locked, or tuned, to a given frequency prior to the UE being put into service, there can be some residual drift in the frequency of a UE clock after calibration. This residual drift is referred to as “clock drift,” and can often be temperature dependent. Although UE positioning operations involve timing related to exchanged messages, these operations usually focus on relative timings of, or differences in timing between, transmitted and received messages rather than absolute arrival or departure times. As such, clock drift at the UE does not typically degrade the accuracy of the positioning techniques. However, UE clock drift can affect other types of positioning operations.

As artificial intelligence (AI) and machine learning (ML) technology has advanced, AI and ML models have become increasingly sophisticated and are able to be used in a wide variety of applications. One such application is device positioning for wireless communication systems. As an example, an ML positioning model may be trained using training data based on positioning data from UEs at particular locations. Such training enables the ML positioning model to learn site specific features that improve the accuracy of predicted locations that are output by the trained ML model. However, because of the training process and the specificity of the features, the ML model can be sensitive to changes in timing information that are caused by UE clock drift. For example, timing variation of one nanometer caused by UE clock drift can translate to tens of centimeters variation in predicted position, which can degrade the accuracy of ML and AI-based positioning in wireless communication systems.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In one aspect of the disclosure, a method for wireless communication is performed by a user equipment (UE). The method includes receiving positioning configuration information from a network entity. The method also includes performing, based on the positioning configuration information, one or more positioning operations with respect to one or more wireless communication channels. The method further includes transmitting, to a training entity to enable training of a machine learning (ML) positioning model to account for UE clock drift, one or more positioning measurements generated based on performance of the one or more positioning operations.

In an additional aspect of the disclosure, a UE is configured for wireless communication. The UE includes a memory and at least one processor coupled to the memory. The memory stores processor-readable code. The at least one processor is configured to execute the processor-readable code to cause the at least one processor to receive positioning configuration information from a network entity. The at least one processor is also configured to perform, based on the positioning configuration information, one or more positioning operations with respect to one or more wireless communication channels. The at least one processor is further configured to transmit, to a training entity to enable training of an ML positioning model to account for UE clock drift, one or more positioning measurements generated based on performance of the one or more positioning operations.

In an additional aspect of the disclosure, an apparatus for wireless communication includes means for means for receiving positioning configuration information from a network entity. The apparatus also includes means for performing, based on the positioning configuration information, one or more positioning operations with respect to one or more wireless communication channels. The apparatus further includes means for transmitting, to a training entity to enable training of an ML positioning model to account for clock drift, one or more positioning measurements generated based on performance of the one or more positioning operations.

In an additional aspect of the disclosure, a non-transitory, computer-readable medium stores instructions that, when executed by a processor of a UE, cause the processor to perform operations. The operations include receiving positioning configuration information from a network entity. The operations also include performing, based on the positioning configuration information, one or more positioning operations with respect to one or more wireless communication channels. The operations further include transmitting, to a training entity to enable training of an ML positioning model to account for UE clock drift, one or more positioning measurements generated based on performance of the one or more positioning operations.

In an additional aspect of the disclosure, an apparatus includes a communication interface configured to receive positioning configuration information from a network entity. The apparatus further includes at least one processor coupled to a memory storing processor-readable code. The at least one processor is configured to execute the processor-readable code to cause the at least one processor to initiate, based on the positioning configuration information, performance of one or more positioning operations with respect to one or more wireless communication channels. The communication interface is further configured to transmit, to a training entity to enable training of an ML positioning model to account for UE clock drift, one or more positioning measurements generated based on performance of the one or more positioning operations.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of an example wireless communication system according to one or more aspects.

FIG. 2 is a block diagram illustrating examples of a base station and a user equipment (UE) according to one or more aspects.

FIG. 3 shows a diagram illustrating an example disaggregated base station architecture according to one or more aspects.

FIG. 4 is a block diagram illustrating an example wireless communication system that supports machine learning (ML)-based positioning that mitigates UE clock drift according to one or more aspects.

FIGS. 5A and 5B illustrate examples of a UE providing multiple positioning measurements at a fixed location to mitigate UE clock drift in training an ML positioning model according to one or more aspects.

FIGS. 6A and 6B illustrate examples of a UE providing augmented positioning measurements at a fixed location to mitigate UE clock drift in training an ML positioning model according to one or more aspects.

FIGS. 7A and 7B illustrate examples of a UE providing positioning measurements at a fixed location and sharing clock drift information to mitigate UE clock drift in training an ML positioning model according to one or more aspects.

FIG. 8 is a flow diagram illustrating an example process that supports ML-based positioning that mitigates UE clock drift according to one or more aspects.

FIG. 9 is a block diagram of an example UE that supports ML-based positioning that mitigates UE clock drift according to one or more aspects.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described examples can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO. The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IoT) network.

Various aspects relate generally to wireless communication and more particularly to machine learning (ML)-based positioning that mitigates or accounts for user equipment (UE) clock drift. Some aspects more specifically relate to positioning configuration and associated signaling that enable a UE to provide positioning measurements, and optionally additional information, as part of a process for gathering training data to train an ML positioning model to predict a location of the UE based on positioning measurements. In some examples, a network entity, such as a base station, may transmit positioning configuration information to the UE to cause the UE to monitor for positioning reference signals (PRSs) that are transmit by one or more transmit/receive points (TRPs) and to report measurements associated with the PRSs to a training entity. The training entity may be a location management function (LMF) hosted at a server within a core network associated with the network entity, a third party ML service provider, or a system or device that is communicatively coupled to the UE, such as by a vendor or programmer of the UE. In some examples, the positioning configuration information may indicate one or more positioning occasions or a positioning duration during which the UE is to remain at a fixed location and transmit multiple positioning measurements based on the received PRSs. In some other examples, the positioning configuration information may include an instruction, and optionally one or more clock drift parameters, to cause the UE to augment (e.g., adjust) initial positioning measurements with simulated clock drift measurements before transmitting the augmented positioning measurements to the training entity. In some other examples, the positioning configuration information may include a request to cause the UE to provide clock drift information associated with the UE to the training entity along with the positioning measurements. Although described as distinct techniques, the UE may be configured to perform a hybrid technique that combines two or more of these techniques for providing positioning measurements to the training entity. As a result of the UE performing the positioning operations indicated by the positioning configuration information, the training entity may use the positioning measurements, the augmented positioning measurements, the clock drift information, or a combination thereof, as training data to train an ML model to predict a location of a UE based on input positioning measurements, such as the results of measuring the PRSs from the TRPs.

Particular aspects of the subject matter described in this disclosure can be implemented to realize one or more of the following potential advantages. Training data that includes multiple positioning measurements from the same location or that is augmented based on simulated clock drift measurements may account for and mitigate the effects of clock drift on ML-based positioning. In some examples, by training an ML positioning model using training data that is based on a larger number of positioning measurements for the same location or based on augmented positioning measurements, aspects of the present disclosure may increase the accuracy of ML-based positioning in a wireless communication system. More specifically, the trained ML positioning model may be able to receive input data that has variations due to clock drift at the UE from which it is received, and the ML positioning model may predict a location of the UE that is more accurate because the variations due to clock drift are learned by the ML positioning model during the training. As such, aspects of the present disclosure may achieve more accurate positioning estimates for devices in wireless communication systems using ML-based positioning.

This disclosure relates generally to providing or participating in authorized shared access between two or more wireless devices in one or more wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5th Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP LTE is a 3GPP project which was aimed at improving UMTS mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1 M nodes/km2), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜ 1 millisecond (ms)), and users with wide ranges of mobility or lack thereof; and (3) with enhanced mobile broadband including extreme high capacity (e.g., ˜ 10 Tbps/km2), extreme data rates (e.g., multi-Gbps rate, 100+ Mbps user experienced rates), and deep awareness with advanced discovery and optimizations.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHZ-7.125 GHZ) and FR2 (24.25 GHZ-52.6 GHZ). The frequencies between FR1 and FR2 are often referred to as mid-band frequencies. Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHZ-300 GHz) which is identified by the International Telecommunications Union (ITU) as a “mm Wave” band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHZ FDD or TDD implementations, subcarrier spacing may occur with 15 kHz, for example over 1, 5, 10, 20 MHZ, and the like bandwidth. For other various outdoor and small cell coverage deployments of TDD greater than 3 GHZ, subcarrier spacing may occur with 30 kHz over 80/100 MHz bandwidth. For other various indoor wideband implementations, using a TDD over the unlicensed portion of the 5 GHZ band, the subcarrier spacing may occur with 60 kHz over a 160 MHz bandwidth. Finally, for various deployments transmitting with mmWave components at a TDD of 28 GHZ, subcarrier spacing may occur with 120 kHz over a 500 MHz bandwidth.

The scalable numerology of 5G NR facilitates scalable TTI for diverse latency and quality of service (QOS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

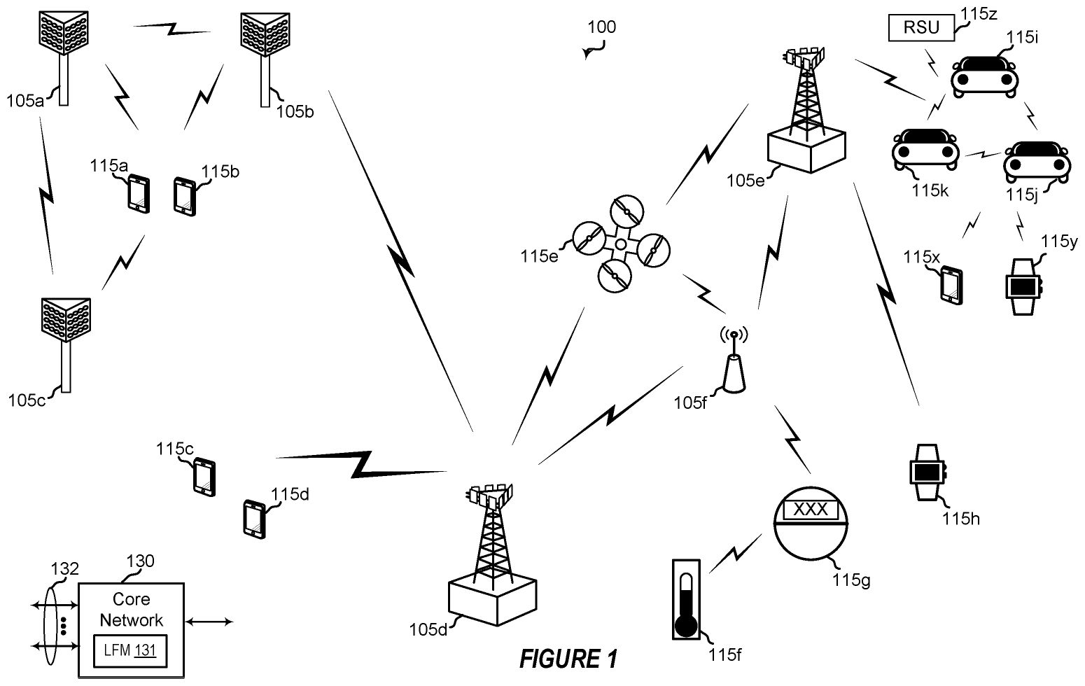

FIG. 1 is a block diagram illustrating details of an example wireless communication system according to one or more aspects. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” may refer to this particular geographic coverage area of a base station or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100 A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 100 may occur using wired or wireless communication links.

In operation at wireless network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports mission critical communications with ultra-reliable and redundant links for mission critical devices, such UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD communications or low-latency FDD communications, such as in a vehicle-to-vehicle (V2V) mesh network between UEs 115i-115k communicating with macro base station 105e. Additionally, V2V mesh network may include or correspond to a vehicle-to-everything (V2X) network between UEs 115i-115k and one or more other devices, such as UEs 115x, 115y, or UE 115z (e.g., a roadside unit (RSU)).

Base stations 105 may communicate with a core network 130 and with one another. For example, base stations 105 may interface with the core network 130 through backhaul links 132 (e.g., via an S1, N2, N3, or other interface). Base stations 105 may communicate with one another over backhaul links (e.g., via an X2, Xn, or other interface) either directly (e.g., directly between base stations 105) or indirectly (e.g., via core network 130).

Core network 130 may provide user authentication, access authorization, tracking, Internet Protocol (IP) connectivity, and other access, routing, or mobility functions. The core network 130 may be an evolved packet core (EPC), which may include at least one mobility management entity (MME), at least one serving gateway (S-GW), and at least one packet data network (PDN) gateway (P-GW). The MME may manage non-access stratum (e.g., control plane) functions such as mobility, authentication, and bearer management for UEs 115 served by base stations 105 associated with the EPC. User IP packets may be transferred through the S-GW, which itself may be connected to the P-GW. The P-GW may provide IP address allocation as well as other functions. The P-GW may be connected to the network operators IP services. The operators IP services may include access to the Internet, Intranet(s), an IP multimedia subsystem (IMS), or a packet-switched (PS) streaming service.

In some implementations, core network 130 includes or is coupled to a management function, such as a Location Management Function (LMF) 131, a Sensing Management function (SnMF), or an Access and Mobility Management Function (AMF), which is an entity in the 5G Core Network (5GC) supporting various functionality, such as managing support for different location services for one or more UEs. The SnMF may be configured to manage support for one or more sensing operations or sensing services for one or more devices, such as one or more UEs 115, one or more base stations 105, one or more TRPs, or a combination thereof. For example the SnMF may include one or more servers, such as multiple distributed servers. Base stations 105 may forward sensing messages to the SnMF and may communicate with the SnMF via a NR Positioning Protocol A (NRPPa). The SnMF is configured to control sensing parameters for UEs 115 and the SnMF can provide information to the base stations 105 and UE 115 so that action can be taken at UE 115, base station 105, or another device. LMF 131 may include one or more servers, such as multiple distributed servers. Base stations 105 may forward location messages to LMF 131 and may communicate with LMF 131 via a NR Positioning Protocol A (NRPPa). LMF 131 is configured to control the positioning parameters for UEs 115 and LMF 131 can provide information to base station 105 and UE 115 so that action can be taken at UE 115. In some implementations, UE 115 and base station 105 are configured to communicate with LMF 131 via the AMF.

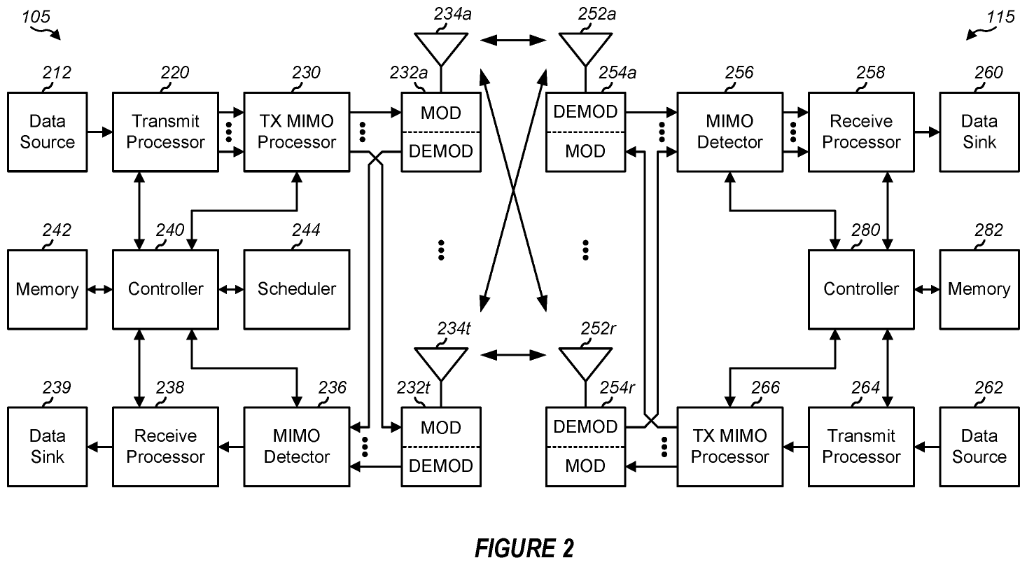

FIG. 2 is a block diagram illustrating examples of base station 105 and UE 115 according to one or more aspects. Base station 105 and UE 115 may be any of the base stations and one of the UEs in FIG. 1. For a restricted association scenario (as mentioned above), base station 105 may be small cell base station 105f in FIG. 1, and UE 115 may be UE 115c or 115d operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from controller 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller 280, such as a processor.

On the uplink, at UE 115, transmit processor 264 may receive and process data (e.g., for a physical uplink shared channel (PUSCH)) from data source 262 and control information (e.g., for a physical uplink control channel (PUCCH)) from controller 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to controller 240.

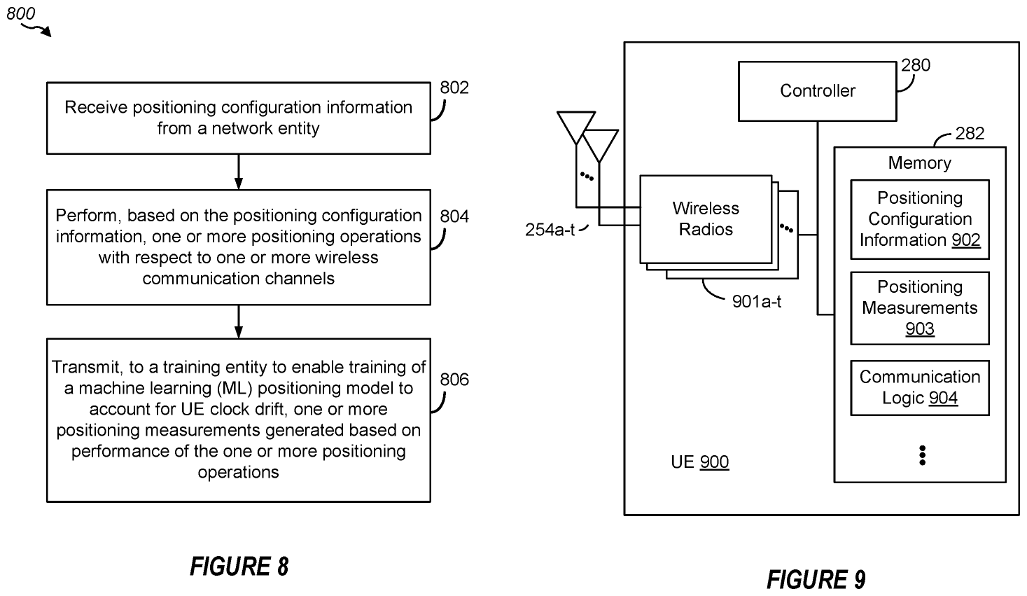

Controllers 240 and 280 may direct the operation at base station 105 and UE 115, respectively. Controller 240 or other processors and modules at base station 105 or controller 280 or other processors and modules at UE 115 may perform or direct the execution of various processes for the techniques described herein, such as to perform or direct the execution illustrated in FIG. 8, or other processes for the techniques described herein. Memories 242 and 282 may store data and program codes for base station 105 and UE 115, respectively. Scheduler 244 may schedule UEs for data transmission on the downlink or the uplink.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel or the acknowledge/negative-acknowledge (ACK/NACK) feedback for its own transmitted packets as a proxy for collisions.

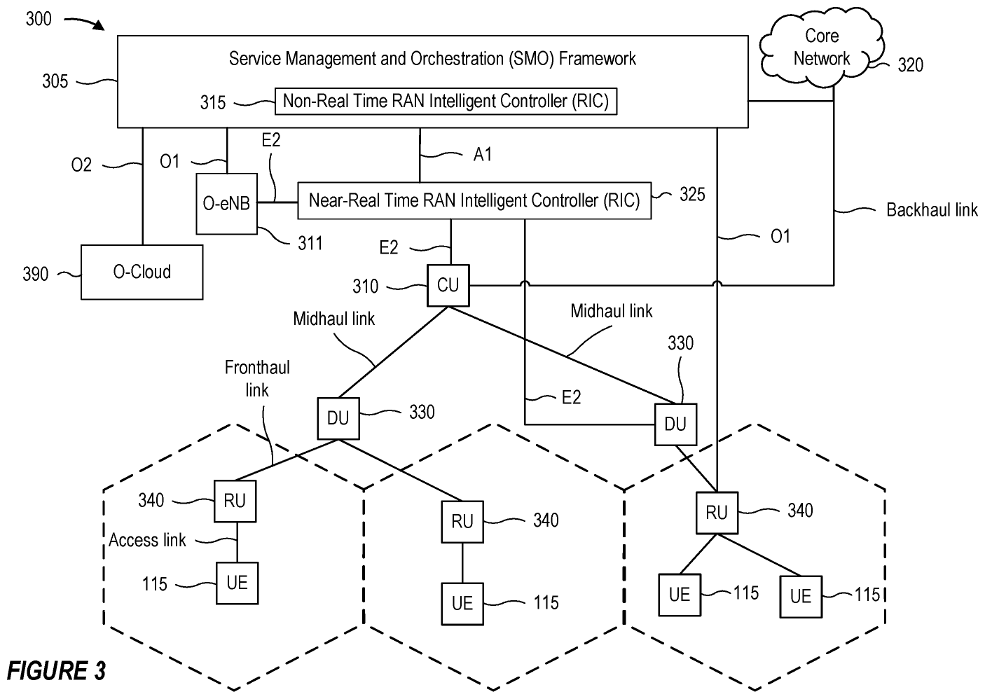

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). Core network 320 may include or correspond to core network 130. A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 115 via one or more radio frequency (RF) access links. In some implementations, the UE 115 may be simultaneously served by multiple RUs 340.

Each of the units, i.e., the CUS 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 115. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUS 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

As described herein, a node (which may be referred to as a node, a network node, a network entity, or a wireless node) may include, be, or be included in (e.g., be a component of) a base station (e.g., any base station described herein), a transmission and reception point (TRP), a UE (e.g., any UE described herein), a network controller, an apparatus, a device, a computing system, an integrated access and backhauling (IAB) node, a distributed unit (DU), a central unit (CU), a remote unit (RU), a core network, a LFM, and/or a another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first one or more components, a first processing entity, or the like configured to receive the information; and the second network node may refer to a second UE, a second base station, a second apparatus, a second device, a second computing system, a second one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

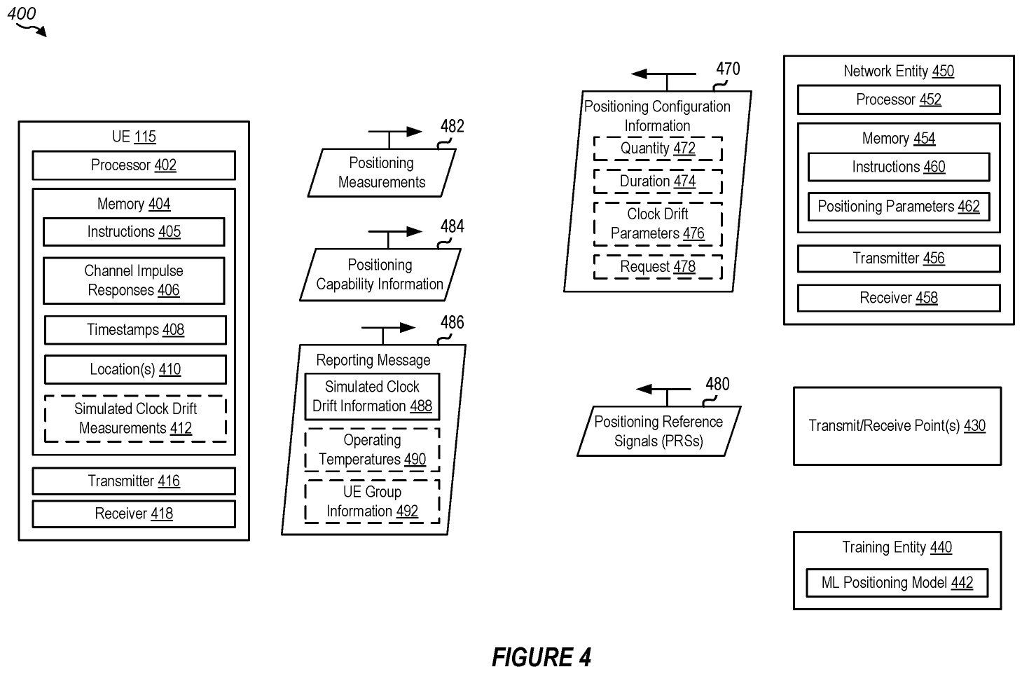

FIG. 4 is a block diagram of an example wireless communications system 400 that supports ML-based positioning that mitigates UE clock drift according to one or more aspects. In some examples, wireless communications system 400 may implement aspects of wireless network 100. Wireless communications system 400 includes UE 115, one or more transmit/receive points (TRPs) (hereinafter referred to collectively as “transmit/receive points 430” or “TRPs 430”), a training entity 440, and a network entity 450. Although one UE 115, one TRP 430, one training entity 440, and one network entity 450 are illustrated, in some other implementations, wireless communications system 400 may generally include multiple UEs 115, multiple TRPs 430, more than one training entity 440 (or training entity 440 may be included in network entity 450), multiple network entities 450, or a combination thereof.

UE 115 may include a device, such as a mobile device, a robot, an autonomous machine, or a vehicle. As an illustrative example, UE 115 may include a robot, an automated ground vehicle (AGV), an unmanned aerial vehicle (UAV) (e.g., a drone), a self-driving vehicle, or any other type of autonomous or semi-autonomous land craft, watercraft, aircraft, or combination thereof, that is configured to traverse a predefined region, such as between multiple designated locations. As a non-limiting example, UE 115 may include a robot that is configured to load and unload shelves in a warehouse. As another non-limiting example, UE 115 may include an AGV that is configured to carry passengers between a plurality of designated drop-off points. Although some examples of UE 115 are referred to herein as vehicles, UE 115 may instead be included in or integrated within an onboard unit (OBU) of a vehicle. Alternatively, UE 115 may be a mobile device that is carried by a user or a vehicle or machine about the region (e.g., about the multiple designated locations). For example, UE 115 may include a smart phone, a tablet computer, a smart device, or the like. As further described herein, UE 115 may be configured to record positioning measurements at one or more locations (e.g., within the region) as part of a process to create training data for an ML positioning model. Alternatively, UE 115 may be free to move (e.g., have no movement restrictions), and UE 115 may provide measurements from any requested location as part of the process to create the training data.

UE 115 may include a variety of components (such as structural, hardware components) used for carrying out one or more functions described herein. For example, these components may include one or more processors 402 (hereinafter referred to collectively as “processor 402”), one or more memory devices 404 (hereinafter referred to collectively as “memory 404”), one or more transmitters 416 (hereinafter referred to collectively as “transmitter 416”), and one or more receivers 418 (hereinafter referred to collectively as “receiver 418”). In some implementations, UE 115 may include an interface (e.g., a communication interface) that includes transmitter 416, receiver 418, or a combination thereof. Processor 402 may be configured to execute instructions 405 stored in memory 404 to perform the operations described herein. In some implementations, processor 402 includes or corresponds to one or more of receive processor 258, transmit processor 264, and controller 280, and memory 404 includes or corresponds to memory 282.

Memory 404 includes or is configured to store instructions 405, one or more channel impulse responses (CIRs) (hereinafter referred to collectively as “channel impulse responses 406” or “CIRs 406”), one or more timestamps (hereinafter referred to collectively as “timestamps 408”), one or more locations (hereinafter referred to collectively as “locations 410”), and in some implementations, simulated clock drift measurements 412. CIRs 406 may include timing information, power information, phase information, or a combination thereof. As described further herein, CIRs 406 may include CIRs measured by UE 115 with respect to a communication channel via which reference signaling is received, such as positioning reference signals (PRSs) or sensing reference signals (SRSs). Timestamps 408 indicate timing when CIRs 406 are measured. For example, each CIR of CIRs 406 may be associated with a respective timestamp of timestamps 408 that indicates a time, as measured by a clock of UE 115, at which the CIR was measured. Locations 410 may include locations at which UE 115 measured one or more of CIRs 406. Simulated clock drift measurements 412 may include one or more measurements related to, or values that represent aspects of, clock drift that has been previously detected at UE 115, or at a representative UE of a UE group that includes UE 115 as further described herein.

Transmitter 416 is configured to transmit reference signals, control information and data to one or more other devices, and receiver 418 is configured to receive references signals, synchronization signals, control information and data from one or more other devices. For example, transmitter 416 may transmit signaling, control information and data to, and receiver 418 may receive signaling, control information and data from, network entity 450. In some implementations, transmitter 416 and receiver 418 may be integrated in one or more transceivers. Additionally or alternatively, transmitter 416 or receiver 418 may include or correspond to one or more components of UE 115 described with reference to FIG. 2.

In some implementations, UE 115 may include one or more antenna arrays. The one or more antenna arrays may be coupled to transmitter 416, receiver 418, or a communication interface. The antenna array may include multiple antenna elements configured to perform wireless communications with other devices, such as with network entity 450. In some implementations, the antenna array may be configured to perform wireless communications using different beams, also referred to as antenna beams. The beams may include TX beams and RX beams. To illustrate, the antenna array may include multiple independent sets (or subsets) of antenna elements (or multiple individual antenna arrays), and each set of antenna elements of the antenna array may be configured to communicate using a different respective beam that may have a different respective direction than the other beams. For example, a first set of antenna elements of the antenna array may be configured to communicate via a first beam having a first direction, and a second set of antenna elements of the antenna array may be configured to communicate via a second beam having a second direction. In other implementations, the antenna array may be configured to communicate via more than two beams. Alternatively, one or more sets of antenna elements of the antenna array may be configured to concurrently generate multiple beams, for example using multiple RF chains of UE 115. Each individual set (or subset) of antenna elements may include multiple antenna elements, such as two antenna elements, four antenna elements, ten antenna elements, twenty antenna elements, or any other number of antenna elements greater than two. Although described as an antenna array, in other implementations, the antenna array may include or correspond to multiple antenna panels, and each antenna panel may be configured to communicate using a different respective beam.

Network entity 450 may include a variety of components (such as structural, hardware components) used for carrying out one or more functions described herein. For example, these components may include one or more processors 452 (hereinafter referred to collectively as “processor 452”), one or more memory devices 454 (hereinafter referred to collectively as “memory 454”), one or more transmitters 456 (hereinafter referred to collectively as “transmitter 456”), and one or more receivers 458 (hereinafter referred to collectively as “receiver 458”). In some implementations, network entity 450 may include an interface (e.g., a communication interface) that includes transmitter 456, receiver 458, or a combination thereof. Processor 452 may be configured to execute instructions 460 stored in memory 454 to perform the operations described herein. In some implementations, processor 452 includes or corresponds to one or more of receive processor 238, transmit processor 220, and controller 240, and memory 454 includes or corresponds to memory 242. Memory 454 includes or is configured to store instructions 460 and positioning parameters 462. Positioning parameters 462 may include one or more positioning parameters that configure UEs, such as UE 115, to perform particular positioning operations as part of a process to create training data for training machine learning models, as further described herein.

Transmitter 456 is configured to transmit reference signals, synchronization signals, control information and data to one or more other devices, and receiver 458 is configured to receive reference signals, control information and data from one or more other devices. For example, transmitter 456 may transmit signaling, control information and data to, and receiver 458 may receive signaling, control information and data from, UE 115. In some implementations, transmitter 456 and receiver 458 may be integrated in one or more transceivers. Additionally or alternatively, transmitter 456 or receiver 458 may include or correspond to one or more components of base station 105 described with reference to FIG. 2.

In some implementations, network entity 450 may include one or more antenna arrays. The antenna array may include multiple antenna elements configured to perform wireless communications with other devices, such as with UE 115. In some implementations, the antenna array may be configured to perform wireless communications using different beams, also referred to as antenna beams. The beams may include TX beams and RX beams. To illustrate, the antenna array may include multiple independent sets (or subsets) of antenna elements (or multiple individual antenna arrays), and each set of antenna elements of the antenna array may be configured to communicate using a different respective beam that may have a different respective direction than the other beams. For example, a first set of antenna elements of the antenna array may be configured to communicate via a first beam having a first direction, and a second set of antenna elements of the antenna array may be configured to communicate via a second beam having a second direction. In other implementations, the antenna array may be configured to communicate via more than two beams. Alternatively, one or more sets of antenna elements of the antenna array may be configured to concurrently generate multiple beams, for example using multiple RF chains of network entity 450. Each individual set (or subset) of antenna elements may include multiple antenna elements, such as two antenna elements, four antenna elements, ten antenna elements, twenty antenna elements, or any other number of antenna elements greater than two. Although described as an antenna array, in other implementations, the antenna array may include or correspond to multiple antenna panels, and each antenna panel may be configured to communicate using a different respective beam.

In some implementations, wireless communications system 400 implements a 5G NR network. For example, wireless communications system 400 may include multiple 5G-capable UEs 115 and multiple 5G-capable network entities 450, such as UEs and network entities configured to operate in accordance with a 5G NR network protocol such as that defined by the 3GPP. In some other implementations, wireless communications system 400 implements a 6G network.

TRPs 430 may include or correspond to one or more wireless communication devices that are capable of transmitting reference signals to UEs, such as UE 115. In some examples, TRPs 430 may include one or more positioning nodes distributed throughout the region traversed by UE 115, such as a warehouse, a store, a storage facility, a manufacturing plant, or the like. Additionally or alternatively, TRPs 430 may include antennas or antenna arrays of base stations, such as network entity 450, access points, network nodes, RSUs, other UEs, other network entities, or a combination thereof.

Training entity 440 may include a server or other computing device that is configured to train an ML positioning model 442. In some implementations, training entity 440 is controlled by a third-party that provides ML training or ML services (e.g., a third-party ML service provider). In some other implementations, training entity 440 may include or correspond to a server of a core network, such as core network 130 of FIG. 1, that is communicatively coupled to or includes network entity 450 and that hosts a location management function (LMF) or other management function. In some other implementations, training entity 440 may include or correspond to a system or device that is communicatively coupled to UE 115, such as by a vendor or programmer of UE 115 in order to provide UE 115 with ML positioning model 442. ML positioning model 442 may include one or more types of ML or artificial intelligence (AI) models that are configured to output an estimated location based on input positioning measurements associated with a UE. In some implementations, ML positioning model 442 may include or be implemented as one or more types of ML or AI models or logic, such as one or more neural networks (NNs) or one or more support vector machines (SVMs). As non-limiting examples, ML positioning model 442 may include or correspond to one or more NNs, such as multi-layer perceptron (MLP) networks, convolutional neural networks (CNNs), recurrent neural networks (RNNs), deep neural networks (DNNs), deep learning neural networks (DL networks), long short-term memory (LSTM) NNs, residual NNs (resnet), transformer, or other types of NNs. In other examples, ML positioning model 442 may include or correspond to one or more SVMs or other kind of trainable and machine-executable ML or AI models or logic. Additionally or alternatively, ML positioning model 442 may be implemented as one or more other types of ML models, such as decision trees, random forests, regression models, Bayesian networks (BNs), dynamic Bayesian networks (DBNs), naive Bayes (NB) models, Gaussian processes, hidden Markov models (HMMs), regression models, or the like.

During operation of wireless communications system 400, network entity 450 may transmit positioning configuration information 470 to UE 115 to configure UE 115 to perform one or more positioning operations as part of a process to gather training data for training entity 440 to use in training ML positioning model 442 to predict a location of a UE based on an input position measurement. Although referred to herein as positioning operations, in some other implementations, other types of sensing operations may be performed, such as based on SRSs. Positioning configuration information 470 may indicate the positioning operations to be performed by UE 115 as this process. Although described as being transmitted by network entity 450, in some implementations, positioning configuration information 470 may originate at a location management function (LMF) (e.g., a server that hosts the LMF) or a data collection entity that may be the same as or different from training entity 440, and network entity 450 may be a base station that serves UE 115 and that provides communications from the LMF or data collection agency to UE 115, and vice versa.

In some implementations, UE 115 may transmit positioning capability information 484 to network entity 450 prior to receiving positioning configuration information 470, such as during a, positioning protocol capability exchange between UE 115 and network entity 450, such as an LTE positioning protocol (LPP) capability exchange or a 5G NR positioning protocol capability exchange. In some such implementations, positioning configuration information 470 is included in a positioning protocol assistance data message or a positioning broadcast message that is received by UE 115 from network entity 450, such as LPP assistance data or 5G NR positioning protocol assistance data. Alternatively, positioning capability information 484, positioning configuration information 470, or both, may be exchanged as part of a dedicated ML training-related capability exchange or messaging, which may be described in a wireless communication standard, such as a 3GPP wireless standard. Positioning capability information 484 may indicate one or more positioning operation capabilities at UE 115, one or more clock drift measuring capabilities at UE 115, one or more clock drift adjustment capabilities at UE 115, or a combination thereof, and positioning configuration information 470 may indicate one or more parameters of positioning operations to be performed by UE 115, one or more clock drift parameters to be used by UE 115, a request for clock drift information, or a combination thereof, as further described herein. In some implementations, positioning configuration information 470 includes one or more locations or other parameters indicating where or how often UE 115 is being configured to perform positioning operations, as further described herein.

After receiving positioning configuration information 470, UE 115 may perform, based on positioning configuration information 470, one or more positioning operations with respect to one or more wireless communication channels. The positioning operations may be performed to measure wireless communication channels between UE 115 and the TRPs 430 in order to detect reference signals that are transmitted by the TRPs 430. For example, the positioning operations performed by UE 115 may include monitoring for one or more positioning reference signals (PRSs), one or more sounding reference signals (SRSs), or a combination thereof, from the TRPs 430. In some examples, devices within wireless communications system 400 may be configured to exchange signaling to other devices to perform positioning operations according to one or more wireless positioning techniques. Illustrative positioning techniques include time of arrival (TOA) positioning, time difference of arrival (TDOA) positioning, observed time difference of arrival (OTDOA), angle of arrival (AOA) positioning, angle of departure (AOD) positioning, line of sight (LOS) positioning, non-line of sight (NLOS) positioning, or any other positioning technique. In some implementations, the positioning techniques may be enhanced or implemented using vehicle-to-everything (V2X) services, which may include services for Vehicle-to-Vehicle (V2V), Vehicle-to-Pedestrian (V2P), Vehicle-to-Infrastructure (V2I), and Vehicle-to-Network (V2N). Some such positioning techniques may leverage V2X or other communications over Proximity-based Services (ProSe) Direction Communication (PC5) reference point as defined in 3GPP TS 23.303, and may use wireless communications under Institute of Electrical and Electronics Engineers (IEEE) 1609, Wireless Access in Vehicular Environments (WAVE), Intelligent Transport Systems (ITS), and IEEE 802.11p, on the ITS band of 5.9 GHZ, or other wireless connections directly between entities. Such wireless communications may include or be referred to as sidelink communications. In some implementations, one or more communications that occur in wireless communication system 400 may be compliant with ETSI TR 103 562 V2.1.1 (2019-12).

The positioning operations performed by UE 115 may also include performing one or more measurements of the wireless communication channels associated with the PRSs or SRSs. In some implementations, the measurements include one or more channel impulse responses (CIRs) of the wireless communication channels between UE 115 and TRPs 430 that are performed by UE 115 to detect and measure the PRSs or SRSs that are transmitted by TRPs 430. For example, UE 115 may perform the positioning operations to generate CIRs 406 that indicate detected energy on the wireless communication channels during performance of the positioning operations indicated by positioning configuration information 470. Along with measuring the wireless communication channels to generate CIRs 406, UE 115 may record the times at which CIRs 406 are measured as timestamps 408. In some implementations, when UE 115 is configured to perform positioning operations at multiple different locations, UE 115 may record the location at which CIRs 406 are measured as locations 410. In ideal conditions, UE 115 will receive each PRS or SRS at a determinable time (e.g., based on a time of departure of the PRS or SRS from TRPs 430 and a distance between a location of UE 115 and TRPs 430). However, after deployment of UE 115, conditions such as temperature, components used to set a clock of UE 115, and other factors may cause the clock of UE 115 to drift (e.g., speed up or slow down over time) such that a received signal has a different magnitude than the expected magnitude associated with ideal conditions. For example, if TRPs 430 send PRSs at four designated times such that their expected arrival times are T₁, T₂, T₃, and T₄ for ideal conditions, CIRs corresponding to PRS measurements may have different magnitudes at UE 115 as compared to the magnitudes at TRPs 430 at the corresponding departure times due to clock drift at UE 115. In some examples, the differences can correspond to a difference in nanoseconds between the expected arrival time and the actual arrival time, and thus, even though UE 115 is at a fixed location and the travel time is fixed (e.g., due to a constant distance between UE 115 and TRPs 430), the time of arrival for various PRSs begins to vary. One way to represent this varying arrival time with respect to CIRs is to define CIRs for each PRS with respect to an expected CIR (e.g., if the PRS arrived at the expected arrival time in ideal conditions). For example, if UE 115 is located at a fixed location (x₀, y₀, z₀) and an expected CIR for each of four PRSs at times T₁, T₂, T₃, and T₄ is f if there is no clock drift at UE 115, then the CIRs measured by UE 115 are f+Δf₁ at T₁, f+Δf₂ at T₂, f+Δf₃ at T₃, and f+Δf₄ at T₄, respectively. As such, the variation due to UE clock drift at the four times of PRS transmission may be represented as Δf₁, Δf₂, Δf₃, and Δf₄.

After performing the positioning operations indicated by positioning configuration information 470, UE 115 may transmit, to training entity 440, one or more positioning measurements (referred to herein collectively as “positioning measurements 482”) that are generated based on performance of the positioning operations. Positioning measurements 482 may include all or a subset of the measurements resulting from performance of the positioning operations configured by network entity 450. For example, positioning measurements 482 may include one or more pairs of a respective CIR of CIRs 406 and a respective timestamp of timestamps 408 that is associated with the respective CIR. In some implementations, positioning measurements 482 may further include, for each of one or more of the pairs of CIR and timestamp, a location of locations 410 that corresponds to the respective CIR (e.g., a location of UE 115 during measurement of the respective CIR). UE 115 may transmit positioning measurements 482 to training entity 440 to enable training entity 440 to generate training data to train ML positioning model 442 in a manner that compensates for clock drift at UE 115.

In some examples, training entity 440 may label received position measurements (e.g., CIRs) that correspond to the same location with a corresponding location label (e.g., a ground truth label), and ML positioning model 422 may be trained to receive PRS or SRS measurements (e.g., CIRs) as input data and to predict a target location (e.g., a direct label) of a UE based on the input data. Such examples may be referred to as direct ML/AI positioning. In some other examples, ML positioning model 422 may be trained to output predicted intermediate positioning information or measurements (e.g., intermediate labels), such as arrival or departure timing, arrival or departure angles, LOS identifications, or other types of intermediate positioning information. In such examples, this intermediate positioning information may be input into non-ML based or non-AI based algorithms, such as Chan's Algorithm or a Kalman filter (KF) algorithm, or the intermediate positioning information may be input to a second ML positioning model that is trained to receive intermediate positioning information as input and to output a target location (e.g., a direct label) of a UE based on the input data. Such examples may be referred to as ML/AI assisted positioning. Because ML positioning model 422 is trained based on training data that is designed to compensate for clock drift at UE 115, ML positioning model 422 may output predicted locations that have higher accuracy, and thus greater utility, than predictions output by other types of trained ML positioning models.

As described above, training entity 440 may be included in or associated with the network, such as a component of a core network of wireless communications system 400, training entity 440 may be remote and operated by a third party, or training entity may be local to UE 115. For example, training entity 440 may include or correspond to a server associated with network entity 450, such as a server that hosts a location management function (LMF). Alternatively, training entity 440 may be included in or implemented with network entity 450. Alternatively, training entity 440 may include or correspond to a third part server that is communicatively coupled to the wireless network supported by wireless communications system 400. Alternatively, training entity 440 may include or correspond to a server that is communicatively coupled to UE 115, such as one operated by a UE chip vendor or an over-the-top (OTT) server. After training, ML positioning model 442 may be implemented at various devices to provide direct ML/AI positioning services or ML/AI assisted positioning services. For example, ML positioning model 442 may be implemented in one of the following manners: at UE 115 to provide UE-based positioning with a UE-side model; at UE 115 to provide UE-assisted/LMF-based positioning with a UE-side model; at an LMF to provide UE-assisted/LMF-based positioning with a LMF-side model; at network entity 450 (e.g., a base station) to provide NG-RAN node assisted positioning with a base station-side model; or at the LMF to provide NG-RAN node assisted positioning with a LMF-side model. These examples are not intended to be limiting, and other configurations in which UE 115, network entity 450, or the LMF implement ML positioning model 442 are possible within the context of the techniques described herein. ML positioning model 442 may be provided to other devices by training entity 440 sending trained ML model parameters of ML positioning model 442 to other devices, such as the LMF, network entity 450, UE 115, or any other device or entity, and the receiving devices may use the ML model parameters to instantiate and host a copy of ML positioning model 442. Additionally or alternatively, training entity 440 may provide ML positioning services by hosting ML positioning model 442, such as at a server or one or more cloud resources.

To support multiple types of positioning operations and techniques to compensate for clock drift, network entity 450 may configure UE 115 to perform different types of positioning operations to facilitate training of ML positioning model 442. For example, positioning configuration information 470 may include various parameters that indicate the type of positioning or clock drift mitigation operations to be performed by UE 115. Such operations may include measuring multiple positioning measurements at a same location, augmenting initial positioning measurements with simulated clock drift measurements at UE 115, providing information indicative of UE clock drift to training entity 440 for use as training data for ML positioning model 422, or a hybrid approach that combines any two or more of these operations. Network entity 450 may configure UE 115 to perform a selected positioning procedure by including one or more parameters in positioning configuration information 470, such as one or more of positioning parameters 462. In some examples, positioning parameters 462 may include quantity 472, duration 474, clock drift parameters 476, request 478, or a combination thereof, as further explained below.

In some implementations, network entity 450 may configure UE 115 to perform multiple positioning measurements at a given location in order to mitigate the effects of UE clock drift on training of ML positioning model 422. Such implementations may be used in situations in which movement of UE 115 is restricted between multiple designated locations or within a designated region. As a non-limiting example, UE 115 may be a robot that is configured to traverse between multiple distinct storage locations for moving cargo within a warehouse. In such implementations, network entity 450 may configure UE 115 to collect multiple measurements for a same location in which the measurements encounter different realizations of UE clock drift such that ML positioning model 422 may be trained on multiple measurements at the same location to be robust to such UE clock drift. If the expected UE clock drift is at least somewhat known or predictable, a procedure for data collection can be designed to control the number of measurements that are collected by UE 115 “camping” (e.g., remaining fixed or relatively fixed) at each location in a manner that captures the UE clock drift within the measurements. This procedure of collecting multiple measurements at various locations may impose some constraints on mobility and operations of UE 115 since the UE will be camping at various locations for designated periods of time, but this procedure can be useful when training ML positioning model 422 benefits from “real” (e.g., non-simulated) measurements that capture actual clock drift characteristics at UE 115. Positioning configuration information 470 may indicate for UE 115 to remain at each of one or more locations for a respective amount of time to perform multiple positioning operations before traveling to a next location. For example, positioning configuration information 470 may specify a training data collection session that may run for multiple seconds, minutes, or hours. In some examples, UE 115 may have a preconfigured route or positioning configuration information 470 may indicate a route, and positioning configuration information 470 may indicate restrictions for how long UE 115 is to stay at each location (e.g., stopping points) along the route to perform data collection. In some such implementations, positioning configuration information 470 may include a step size between two locations along the route, and an indication of the time to perform measurements, either as a number of positioning opportunities or as a particular duration. As a non-limiting example, UE 115 may be configured to traverse a route and stop every meter to perform five seconds of measurement and data collection. Although described as stopping, UE 115 may not have to completely stop if UE 115 is travelling at a slow enough speed to not affect the collection of data.

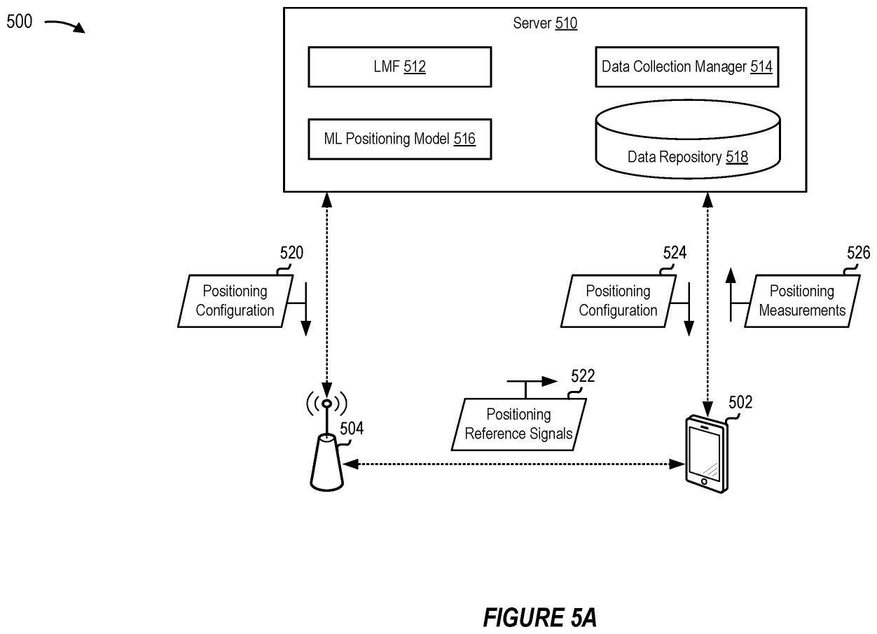

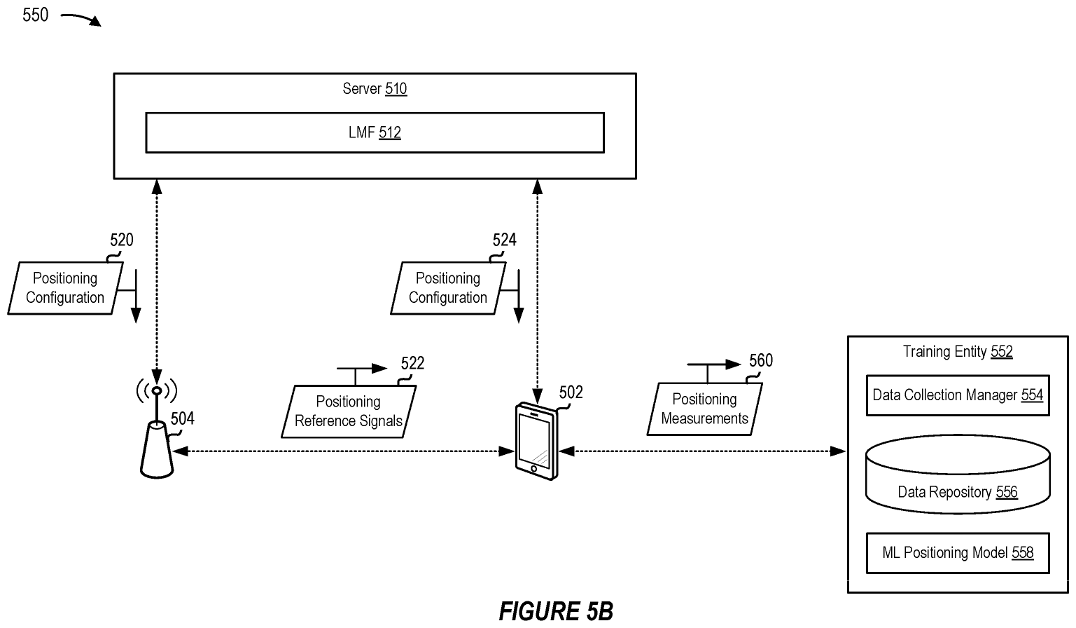

In some such implementations in which UE 115 is configured by positioning configuration information 470 to perform multiple measurements at a given location, positioning configuration information 470 may indicate a quantity 472 of one or more positioning occasions during which UE 115 is to perform positioning operations to measure CIRs 406 and to generate positioning measurements 482. Such positioning occasions may be preconfigured at UE 115 or shared by network entity 450, such as during a positioning protocol exchange, and positioning configuration information 470 may include an indication, such as an index or other identifier, that identifies the positioning occasions assigned to UE 115. Based on quantity 472, UE 115 may perform one or more positioning operations during the associated positioning occasions while remaining at a fixed location to generate at least a portion of positioning measurement 482. Stated another way, UE 115 may engage with N PRS measurement occasions (e.g., where N is represented by quantity 472) to generate multiple measurements of CIRs 406, which may be reported, with corresponding time stamps and location identification, to training entity 440 as positioning measurements 482. In some other implementations, positioning configuration information 470 may indicate a positioning duration 474 for which UE 115 is to perform multiple positioning operations at a given location. For example, UE 115 may move to a designated location and perform multiple positioning operations during duration 474 while remaining fixed at the designated location. Stated another way, UE 115 may engage with PRS measurements for a duration D (e.g., where D is represented by duration 474) to generate multiple measurements of CIRs 406, which may be reported, with corresponding time stamps and location identification, to training entity 440 as positioning measurements 482. Duration 474 may be a universal duration that applies to positioning operations at all locations, or one or more designated locations may be associated with different durations 474. In both implementations (e.g., regardless of whether network entity 450 indicates a number of positioning opportunities or a positioning duration), UE 115 may indicate its positioning capabilities to network entity 450 via positioning capability information 484. For example, positioning capability information 484 may include one or more indices of supported positioning opportunities or one or more supported positioning durations, and optionally other positioning capabilities such as one or more supported training data generation procedure durations, one or more supported routes, one or more supported locations, one or more supported quantities of positioning opportunities, one or more supported positioning periodicities, or a combination thereof. Examples of a UE performing multiple positioning measurements at a given location are described further herein with reference to FIGS. 5A and 5B.

In some implementations, network entity 450 may configure UE 115 to augment recorded measurements such that the measurements vary due to simulated clock drift at UE 115. Such implementations may be used in situations in which movement of UE 115 is not restricted (e.g., UE 115 is free to move without restrictions on locations), and instead of requiring UE 115 to remain at various locations for longer periods of time, UE 115 may generate a single (or a few) position measurements at each location and augment each measurement with one or more simulated measurements that vary due to simulated clock drift. As such, artificial random UE clock drift (e.g., simulated clock drift) is added during training of ML positioning model 422 to enable the model to learn to account for artificial UE clock drift that mimics actual variations that will occur in input data due to UE clock drift. If the UE clock drift is at least somewhat studied and measured, training entity 420 may determine an amount of simulated clock drift that is be added to the training data, a number of samples with simulated clock drift to add, or both. Because either UE 115 or training entity 440 may add samples based on simulated clock drift to the training data, ML positioning model 442 may be trained with training data that mimics the training data generated by having UE 115 perform multiple measurements at each location, and thus ML positioning model 442 may be trained with more relaxed UE mobility and camping requirements than if UE 115 is configured to perform multiple positioning operations at each location. This procedure may be successful in training ML positioning model 442 to account for UE clock drift if the UE clock drift distribution is well-estimated or characterized and meaningful random artificial clock drift can be simulated such that additional samples can be added to the training data.

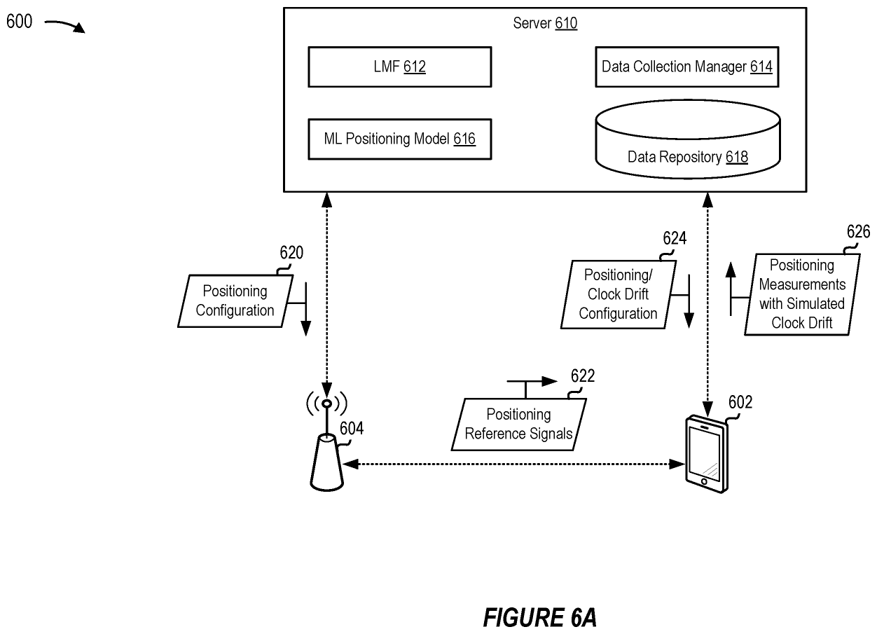

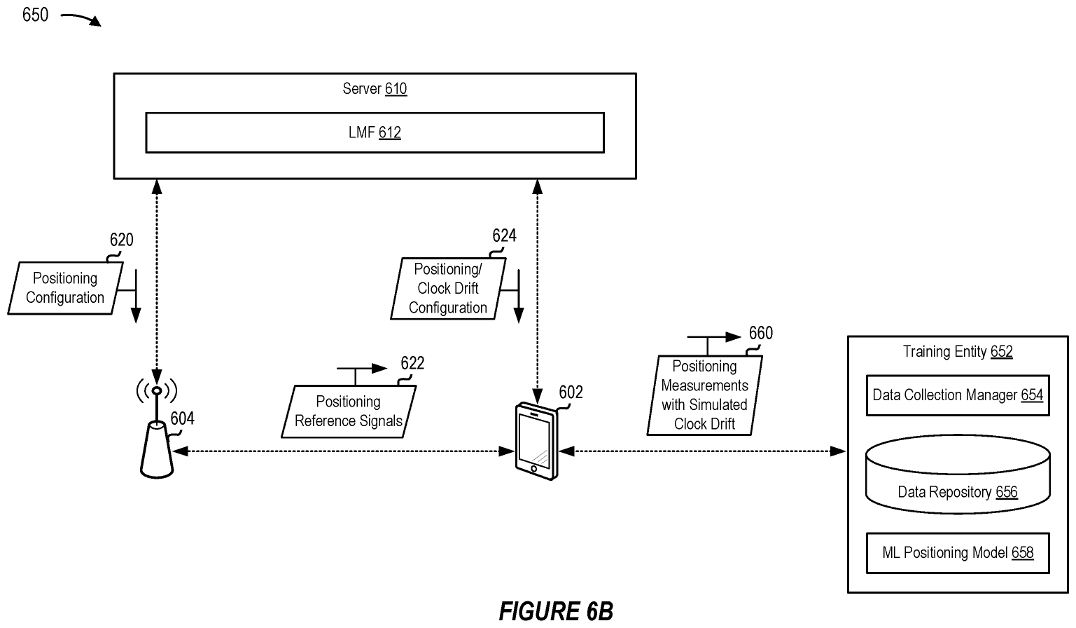

In some implementations, network entity 450 may configure UE 115 to add simulated clock drift to recorded positioning measurements. For example, positioning configuration information 470 may include or be interpreted as an instruction to UE 115 to add simulated clock drift to reported positioning measurements. Based on receiving the instruction (e.g., positioning configuration information 470), UE 115 may perform positioning operations to generate initial positioning measurements (e.g., CIRs 406), and UE 115 may adjust the initial positioning measurements based on simulated clock drift measurements 412 to generate positioning measurements 482 that are transmitted to training entity 440. As an illustrative example, UE 115 may artificially change aspects of a measured CIR by adding phase information to the frequency domain to generate one or more additional CIRs (e.g., artificially-generated or simulated CIRs) that represent CIRs to which simulated clock drift is added. Simulated clock drift measurements 412 may be preprogrammed at UE 115 and may include phase measurements, frequency measurements, statistical measurements, or other measurements that represent actual clock drift at UE 115, such as based on study by a UE vendor, a UE manufacturer, or a UE chip designer. This information may be specific to each UE or to groups or classes of UEs, such as due to similarities in design, components, etc. Such information may be proprietary, and as such, the UE vendor or manufacturer may not wish to share the information with training entity 440, but may consent to storing simulated clock drift measurements 412 at UE 115 so that UE 115 can generate simulated positioning measurements that represent the measured clock drift. Such measurements may include any or all of the types of simulated clock drift information described further herein in the context of being reported to training entity 440. In some implementations, UE 115 may not store simulated clock drift measurements 412, and instead such information may be known to the network (e.g., the LMF), such that network entity 450 may provide this information to UE 115 to generate augmented measurements for sending to training entity 440. For example, network entities and UEs may be designed by a same entity, or simulated clock drift information may not be considered to be of value and thus UE manufacturers or designers may be willing to share such information. In some such examples, positioning configuration information 470 may indicate one or more clock drift parameters (referred to hereinafter collectively as “clock drift parameters 476”), and UE 115 may generate the simulated positioning measurements based on clock drift parameters 476. As an illustrative example, clock drift parameters 476 may include a particular distribution for clock drift to be incorporated with reported measurements, and UE 115 may use the particular distribution to generate additional CIR samples for inclusion, with the same timestamp and location identification as the original CIR, in positioning measurements 482 that are provided to training entity 440. UE 115 may indicate its simulated clock drift capabilities to network entity 450 via positioning capability information 484 so that network entity 450 selects clock drift parameters 476, or an instruction for UE 115 to use its own simulated clock drift measurements 412, that are supported by UE 115. For example, positioning capability information 484 may include one or more supported simulated clock drift generation capabilities or supported clock drift parameters, and network entity 450 may generate positioning configuration information 470 in accordance with positioning capability information 484. Examples of a UE augmenting positioning measurements based on simulated clock drift measurements are described further herein with reference to FIGS. 6A and 6B.

In some implementations, network entity 450 may configure UE 115 to provide information that indicates UE clock drift measurements to training entity 440 for use as training data for ML positioning model 442. For example, positioning configuration information 470 may include a request 478 for UE 115 to provide clock drift information to network entity 450. Based on receiving request 478 in positioning configuration information 470, UE 115 may send simulated clock drift information 488 to training entity 440 to enable training entity 440 to add simulated clock drift measurements to positioning measurements 482 to generate training data for ML positioning model 442. Simulated clock drift information 488 indicates an expected (e.g., studied or measured) UE clock drift at UE 115. UE 115 may signal simulated clock drift information 488 as part of a capability exchange procedure, such as a positioning protocol capability exchange between UE 115 and network entity 450 or training entity 440. For example, UE 115 may include simulated clock drift information 488 in a reporting message 486 that is transmitted by UE 115 to training entity 440 (e.g., during a capability exchange). Alternatively, UE 115 may transmit reporting message 486 to training entity 440 based on receiving a request from network entity 450. Alternatively, UE 115 may include simulated clock drift information 488, and any other information from reporting message 486, with positioning measurements 482. Training entity 440 may use simulated clock drift information 488 to generate additional samples for training data by adjusting positioning measurements 482 based on simulated clock drift information 488 in a same manner as described above with respect to UE 115 generating augmented positioning measurements based on simulated clock drift measurements 412 and CIRs 406.

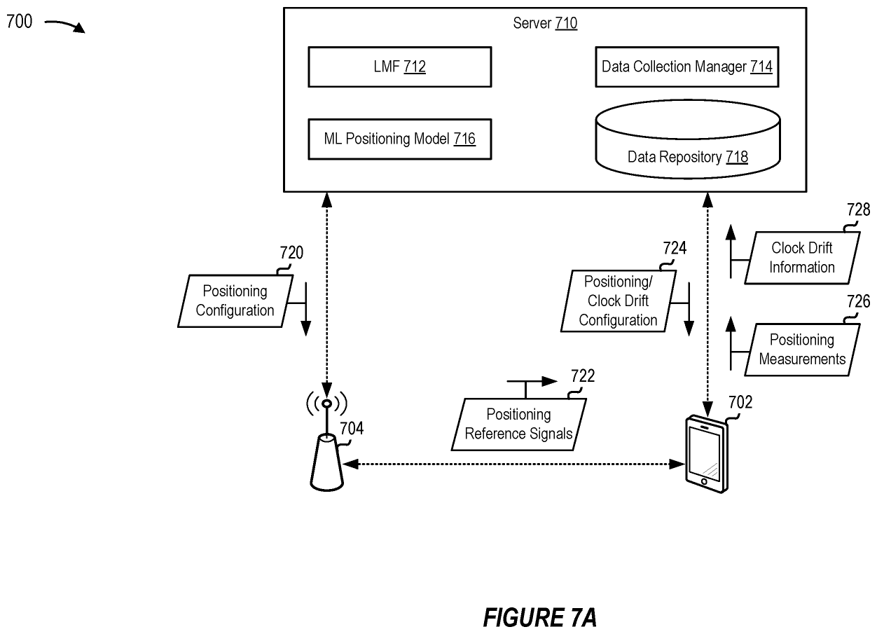

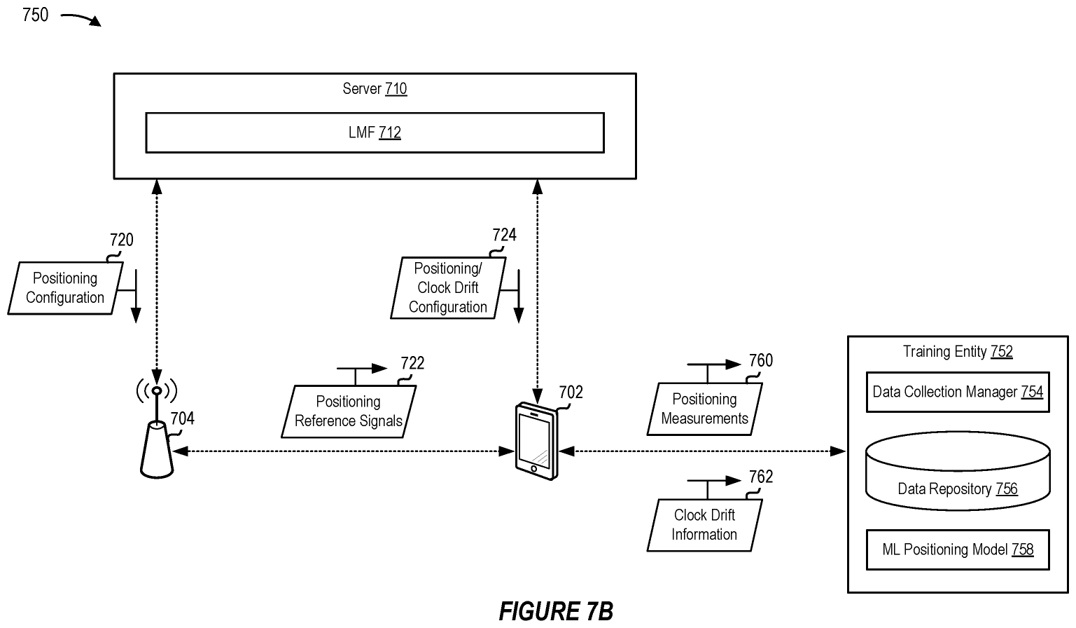

Similar to as described above for simulated clock drift measurements 412, simulated clock drift information 488 may include one or more phase, frequency, or statistical values that represent measured clock drift for UE 115 (or a similar UE group or class). Such values may have been determined in a lab setting and provided by a manufacturer of UE 115. For example, simulated clock drift information 488 may include a median value of UE clock drift, a mean value of UE clock drift, a standard deviation value of UE clock drift, a UE clock drift value for a given percentile, a range of UE clock drift values, a probability distribution that describes the UE clock drift (e.g., a truncated gaussian distribution, a uniform distribution etc.), instantaneous clock drift estimations (which may be sent with positioning measurements 482), or a combination thereof. In some implementations, reporting message 486 further includes operating temperatures 490 associated with simulated clock drift information 488 (or portions thereof). For example, operating temperatures 490 may represent supported temperatures (e.g., ranges of temperatures for which simulated clock drift information 488, or a portion thereof, is valid). In some examples, simulated clock drift information 488 may be provided on a finer granularity in which each clock drift parameter corresponds to a list of one or more of operating temperatures 490. Indicating operating temperatures 490 may be useful to train ML positioning model 442 to be robust for different operating temperatures and to improve accurate during different seasons or times of the day, month, or year in which temperature fluctuates according to known patterns. This is because temperature can affect the magnitude of UE clock drift, such as increasing UE clock speed in higher temperatures or slowing down UE clock speed in lower temperatures. Additionally or alternatively, reporting message 486 may further include UE group information 492 that indicating a group of UEs associated with simulated clock drift information 488. For example, UE 115 may indicate whether simulated clock drift information 488 applies to a group or class (e.g., a type) of UEs by including a group or class identifier as UE group information 492 in reporting message 486. In some examples, certain categories or classes of UEs or UEs manufactured by the same vendor may exhibit common or similar UE clock drift and thus UE 115 may provide UE group information 492 to enable network entity 450 to refrain from probing other UEs of the same group or class for respective clock drift information. This reduces signaling overhead in the wireless network compared to network entity probing each UE individually. Because UEs of a same class or that are manufactured by a same manufacturer may share a common electronic design or similar components from the same sources, there may be similarities to the UE clock drift of these UEs. As a non-limiting example, an inexpensive UE may be designed with constraints that are more relaxed in terms of accuracy, quality, etc., and thus the clock drift would be expected to be within a larger range than a more expensive UE that is designed with tighter constraints. Examples of a UE sharing simulated clock drift information are described further herein with reference to FIGS. 7A and 7B.

As described with reference to FIG. 4, the present disclosure provides techniques for supporting ML-based positioning that mitigates UE clock drift. The techniques described with reference to FIG. 4 result in the generation of training data that includes multiple positioning measurements from the same location or that is augmented based on simulated clock drift measurements, which may account for and mitigate the effects of clock drift on ML-based positioning. For example, UE 115 may perform multiple positioning operations at a particular location to generate positioning measurements 482, such as during multiple positioning opportunities associated with quantity 472 or during positioning duration 474. As another example, UE 115 may augment positioning measurements 482 based on simulated clock drift measurements 412 prior to transmission to training entity 440. As yet another example, UE 115 may share simulated clock drift information 488 (e.g., as part of reporting message 486) for use in generating the training data. In still other examples, a hybrid approach that combines two or more of these techniques may be utilized by UE 115 and training entity 440. By training ML positioning model 442 using training data that is based on a larger number of positioning measurements for the same location or based on augmented positioning measurements, the accuracy of predicted locations output by training entity 440 may be increased. More specifically, ML positioning model 442 may be able to receive input data that has variations due to clock drift at UE 115 (or another UE) from which it is received, and ML positioning model 442 may predict a location of UE 115 that is more accurate because the variations due to clock drift are learned by ML positioning model 442 during the training. As such, wireless communications system 400 may achieve more accurate positioning estimates for devices using ML positioning model 442 than positioning estimates generated using conventional ML-based positioning techniques.

FIGS. 5A and 5B illustrate examples of a UE providing multiple positioning measurements at a fixed location to mitigate UE clock drift in training an ML positioning model according to one or more aspects. FIG. 5A depicts an example in which the network is the training entity for an ML positioning model, and FIG. 5B depicts an example in which a training entity for an ML positioning model is distinct from the network, such as a third party entity or a UE manufacturer, UE vendor, or UE chip designer, as non-limiting examples.

Referring to FIG. 5A, a wireless communications system 500 includes UE 502, a TRP 504, and a server 510. In some implementations, wireless communications system 500 (or components thereof) includes or corresponds to wireless communications system 400 of FIG. 4 (or components thereof). For example, UE 502 may include or correspond to UE 115, TRP 504 may include or correspond to TRPs 430, and server 510 may include or correspond to training entity 440. In some implementations, server 510 is a server or other network component of a core network that communicates with UE 502 and TRPs 504. Although communication links are shown in FIG. 5A between server 510 and UE 502, and between server 510 and TRP 504, such links may not be direct communication links. Instead, server 510 may communicate with one or more intermediate network entities, such as one or more base stations, that communicate directly with UE 502 or TRP 504.

In the example shown in FIG. 5A, server 510 includes LMF 512, data collection manager 514, ML positioning model 516, and data repository 518. LMF 512 may be a location management function that is hosted at server 510 and is configured to perform location management for UEs and other devices within wireless communications system 500. In some examples, LMF 512 may include or correspond to LMF 131 of FIG. 1. Data collection manager 514 may be configured to manage the collection of positioning data to be used as training data to train ML positioning model 516. For example, data collection manager 514, either alone or working with LMF 512, may configure TRP 504 to transmit various PRSs, and data collection manager 514 (and LMF 512) may configure UE 502 to perform one or more positioning operations as part of a process to gather training data. Although illustrated as individual components, in some implementations, LMF 512 may perform the functionality described with reference to data collection manager 514. Data received from UE 502 and managed by data collection manager 514 may be stored at data repository 518 (e.g., a database or other storage location). ML positioning model 516 may include one or more ML models, such as NNs, SVMs, or other types of ML or AI models, that are trained to output a predicted location of a UE based on input positioning data from the UE. In some implementations, ML positioning model 516 includes or corresponds to ML positioning model 442 of FIG. 4.

Server 510 may configure UE 502 and TRP 504 to participate in a process to gather training data for ML positioning model 516, which may involve UE 502 moving to one or more designated locations and “camping” (e.g., staying at the respective location for a time period) in order to performing multiple positioning operations and report the resulting measurements to server 510. For example, server 510 may send positioning configuration 520 to TRP 504 and positioning configuration 524 to UE 502. Positioning configuration 520 may include information associated with one or more PRSs or SRSs to be transmitted by TRP 504 to facilitate the process to gather training data. Positioning configuration 524 may include configuration information that indicates or is associated with one or more positioning operations to be performed by UE 502, such as PRSs or SRSs associated with the positioning operations, positioning occasions during which UE 502 is to performing positioning operations, a positioning duration during which UE 502 is to perform positioning operations, locations at which UE 502 is to camp, distances between locations, other information, or a combination thereof. In some implementations, positioning configuration 524 may include or correspond to positioning configuration information 470 of FIG. 4.

Based on receiving positioning configuration 524, UE 502 may camp (e.g., remain located at) a first location to monitor for PRSs 522 that are transmitted by TRP 504. For example, UE 502 may measure multiple CIRs of a wireless communication channel between UE 502 and TRP 504 at various times that correspond to receipt of PRSs 522, and UE 502 may generate a respective timestamp that indicates a time of the corresponding CIR. UE 502 may send the CIRs and timestamps, and optionally location information if UE 502 is configured to perform positioning at multiple locations, as positioning measurements 526 to server 510. As an illustrative example, UE 502 may camp at a fixed location (x₀, y₀, z₀) to perform four positioning operations related to PRSs 522, each at one of the four times T₁, T₂, T₃, or T₄. In other examples, positioning operations may be performed at fewer than four or more that four times. In this example, UE 502 may record four CIR measurements f₁, f₂, f₃, and f₄, at T₁, T₂. T₃, and T₄, respectively. Positioning measurements 526 may include CIR f₁ and associated time stamp T₁, CIR f₂ and associated time stamp T₂. CIR f₃ and associated time stamp T₃, and CIR f₄ and associated time stamp 14, and optionally location information associated with the CIRs and timestamps that indicates the location (x₀, y₀, z₀). Server 510 may generate training data for ML positioning model 516 based on positioning measurements 526. For example, because timestamps T₁. T₂. T₃, and T₄ each correspond to times during the positioning and camping time period associated with UE 502, the training data may include four labeled samples: CIR f₁ with label (x₀, y₀, z₀), CIR f₂ with label (x₀, y₀, z₀), CIR f₃ with label (x₀, y₀, z₀), and CIR f₄ with label (x₀, y₀, z₀). Similar operations may be performed to gather training data that indicates CIRs at other locations, and the training data may be used to train ML positioning model 516 to receive an input CIR f₁ and to output either a predicted UE location (xᵢ, yᵢ, zᵢ) or intermediate positioning information (e.g., LOS, ToA, ToD, AoA, AoD, reference signal time difference (RSTD), reference signal received power (RSRP), reference signal received path power (RSRPP), etc.). Because ML positioning model 516 is trained using training data derived from multiple measured results at any given location, ML positioning model 516 may be trained to account for variations in CIR measurements due to clock drift at UE 502.

FIG. 5B depicts a wireless communications system 550 in which the training entity for an ML positioning model is a third-party or a vendor or programmer of a UE. In the example shown in FIG. 5B, wireless communications system 550 includes UE 502, TRP 504, server 510, and a training entity 552. Server 510 includes LMF 512, as described above with reference to FIG. 5A. Training entity 552 includes data collection manager 554, data repository 556, and ML positioning model 558. Data collection manager 554 may be configured to manage the collection of positioning data to be used as training data to train ML positioning model 558. For example, data collection manager 554 may receive data from UE 502 and manage and store the data at data repository 556 (e.g., a database or other storage location). ML positioning model 558 may include one or more ML models, such as NNs, SVMs, or other types of ML or AI models, that are trained to output a predicted location of a UE based on input positioning data from the UE. In some implementations, training entity 552 includes or corresponds to training entity 440 of FIG. 4, and ML positioning model 558 includes or corresponds to ML positioning model 442 of FIG. 4.

In the example shown in FIG. 5B, server 510 may provide positioning configuration 520 to TRP 504 and positioning configuration 524 to UE 502 to configure UE 502 to perform one or more positioning operations at various fixed positions to monitor for PRSs 522 from TRP 504, similar to as described above with reference to FIG. 5A. However, unlike in the example of FIG. 5A, in this example UE 502, after generating positioning measurements 560 (e.g., CIRs and associated timestamps, and optionally location information), sends positioning measurements 560 to training entity 552, and training entity 552 generates the training data to train ML positioning model 558. As such, server 510 and LMF 512 may configure TRP 504 and UE 502 to perform operations on behalf of training entity 562. Similar to as described with reference to FIG. 5A, UE 502 may move or be moved to multiple different locations at which UE 502 may camp (e.g., remain fixed) to perform multiple positioning operations to generate positioning measurements 560. Because ML positioning model 558 is trained using training data derived from multiple measured results at any given location, ML positioning model 558 may be trained to account for variations in CIR measurements due to clock drift at UE 502.

FIGS. 6A and 6B illustrate examples of a UE providing augmented positioning measurements at a fixed location to mitigate UE clock drift in training an ML positioning model according to one or more aspects. FIG. 6A depicts an example in which the network is the training entity for an ML positioning model, and FIG. 6B depicts an example in which a training entity for an ML positioning model is distinct from the network, such as a third party entity or a UE manufacturer, UE vendor, or UE chip designer, as non-limiting examples.

Referring to FIG. 6A, a wireless communications system 600 includes UE 602, a TRP 604, and a server 610. In some implementations, wireless communications system 600 (or components thereof) includes or corresponds to wireless communications system 400 of FIG. 4 (or components thereof). For example, UE 602 may include or correspond to UE 115, TRP 604 may include or correspond to TRPs 430, and server 610 may include or correspond to training entity 440. In some implementations, server 610 is a server or other network component of a core network that communicates with UE 602 and TRPs 604. Although communication links are shown in FIG. 6A between server 610 and UE 602, and between server 610 and TRP 604, such links may not be direct communication links. Instead, server 610 may communicate with one or more intermediate network entities, such as one or more base stations, that communicate directly with UE 602 or TRP 604. In the example shown in FIG. 6A, server 610 includes LMF 612, data collection manager 614, ML positioning model 616, and data repository 618. LMF 612, data collection manager 614, ML positioning model 616, and data repository 618 include or correspond to LMF 512, data collection manager 514, ML positioning model 516, and data repository 518 of FIG. 5A. Server 610 may send positioning configuration 620 to TRP 604 to configure TRP 604 to transmit PRSs 622, similar to as described with referent to FIGS. 5A-5B.

Server 610 may configure UE 602 to participate in a process to gather training data for ML positioning model 616, which may involve UE 602 moving to one or more locations and measuring a received PRS to generate and provide a positioning measurement as well as to augment position measurements based on simulated clock drift. For example, server 610 may send positioning/clock drift configuration 624 to UE 602. Positioning/clock drift configuration 624 may include configuration information that indicates or is associated with a positioning operation to be performed by UE 602, such as PRSs or SRSs associated with the positioning operation. Because UE 602 is being configured to provide additional simulated measurements, UE 602 may not be restricted to camping at any particular locations for any particular time periods as part of the process. In some implementations, positioning/clock drift configuration 624 may include or correspond to positioning configuration information 470 of FIG. 4. Additionally, positioning/clock drift configuration 624 may indicate a request for augmented positioning measurements, and optionally, one or more clock drift parameters to be used by UE 602 in generating additional samples that represent simulated clock drift.

Based on receiving positioning/clock drift configuration 624, UE 602 may monitor for PRSs 622 that are transmitted by TRP 604, and UE 602 may measure a CIR of a wireless communication channel between UE 602 and TRP 604 at a time that corresponds to receipt of one of PRSs 622. UE 602 may combine the CIR, an associated timestamp, and location information as one positioning measurement (e.g., a sample), and UE 602 may generate additional simulated positioning measurements (e.g., additional samples) by duplicating and combining the positioning measurement with simulate clock drift (e.g., artificial clock drift). For example, UE clock drift at UE 602 may be well-estimated or characterized in a lab setting or through other study or analysis, and UE 602 may store clock drift information that indicates various parameters that define the UE clock drift associated with UE 602. This information may be used to generate simulated CIRs that represent the variation in CIR measurements due to UE clock drift if multiple measurements were performed at the same location. UE 602 may provide the positioning measurement and the additional simulated positioning measurements as positioning measurements with simulated clock drift 626 to server 610. As an illustrative example, UE 602 may perform a positioning operation related to PRSs 622 to record a CIR measurement f₀ at location (x₀, y₀, z₀). UE 602 may also generate four simulated CIRs f₁, f₂, f₃, and f₄ based on clock drift information. In some implementations, an estimated CIR of a PRS with clock drift can be represented by the following equation, where H is the estimated CIR (e.g., of a PRS measurement occasion), \tilde{H}ⱼ is an estimated CIR with artificial (e.g., simulated) clock drift \tilde{Δ}fⱼ, and \tilde{Δ}fⱼ is the artificial clock drift to be included, which may include proper scaling for subcarrier indexing:

$${\tilde{H}}_{j} = H {e}^{- j 2 π {\tilde{Δ f}}_{J}} \qquad Equation 1 - Estimated CIR$$

In the above example, UE 602 may generate five CIRs: CIR f₀, CIR f₁ (with artificial clock drift \tilde{Δ}f₁), CIR f₂ (with artificial clock drift \tilde{Δ}f₂), CIR f₃ (with artificial clock drift \tilde{Δ}f₃), and CIR f₄ (with artificial clock drift \tilde{Δ}f₄). Positioning measurements with simulated clock drift 626 may include CIRs f₀, f₁, f₂, f₃, and f₄, and a common associated time stamp and location information associated with the CIRs and timestamps that indicates the location (x₀, y₀, z₀). Server 610 may generate training data for ML positioning model 616 based on positioning measurements with simulated clock drift 626. For example, the training data may include five labeled samples: CIR f₀ with label (x₀, y₀, z₀), CIR f₁ with label (x₀, y₀, z₀), CIR f₂ with label (x₀, y₀, z₀), CIR f₃ with label (x₀, y₀, z₀), and CIR f₄ with label (x₀, y₀, z₀). Similar operations may be performed to gather training data that indicates CIRs at other locations, and the training data may be used to train ML positioning model 616 to receive an input CIR f₁ and to output either a predicted UE location (xᵢ, yᵢ, zᵢ) or intermediate positioning information (e.g., LOS, ToA, ToD, AoA, AOD, RSTD, RSRP, RSRPP, etc.). Because ML positioning model 616 is trained using training data derived from measurements and simulated measurements that represent UE clock drift for any given location, ML positioning model 616 may be trained to account for variations in CIR measurements due to clock drift at UE 602.

FIG. 6B depicts a wireless communications system 650 in which the training entity for an ML positioning model is a third-party or a vendor or programmer of a UE. In the example shown in FIG. 6B, wireless communications system 650 includes UE 602, TRP 604, server 610, and a training entity 652. Server 610 includes LMF 612, as described above with reference to FIG. 6A. Training entity 652 includes data collection manager 654, data repository 656, and ML positioning model 658. Data collection manager 654 may be configured to manage the collection of positioning data to be used as training data to train ML positioning model 658. For example, data collection manager 654 may receive data from UE 602 and manage and store the data at data repository 656 (e.g., a database or other storage location). ML positioning model 658 may include one or more ML models, such as NNs, SVMs, or other types of ML or AI models, that are trained to output a predicted location of a UE based on input positioning data from the UE. In some implementations, training entity 652 includes or corresponds to training entity 440 of FIG. 4, and ML positioning model 658 includes or corresponds to ML positioning model 442 of FIG. 4.

In the example shown in FIG. 6B, server 610 may provide positioning configuration 620 to TRP 604 and positioning/clock drift configuration 624 to UE 602 to configure UE 602 to perform one or more positioning operations to monitor for PRSs 622 from TRP 604 and to also generate simulated positioning measurements based on simulated clock drift associated with UE 602, similar to as described above with reference to FIG. 6A. However, unlike in the example of FIG. 6A, in this example UE 602, after generating positioning measurements with simulated clock drift 660 (e.g., measured CIRs and simulated CIRs that represent UE clock drift), sends positioning measurements with simulated clock drift 660 to training entity 652, and training entity 652 generates the training data to train ML positioning model 658. As such, server 610 and LMF 612 may configure TRP 604 and UE 602 to perform operations on behalf of training entity 662. Similar to as described with reference to FIG. 6A, UE 602 may be free to move or be moved to any location at which UE 602 may perform a positioning operation and data augmentation to generate positioning measurements with simulated clock drift 660. Because ML positioning model 658 is trained using training data derived from multiple CIRs (e.g., both measured and simulated) for any given location, ML positioning model 658 may be trained to account for variations in CIR measurements due to clock drift at UE 602.

FIGS. 7A and 7B illustrate examples of a UE providing positioning measurements at a fixed location and sharing clock drift information to mitigate UE clock drift in training an ML positioning model according to one or more aspects. FIG. 7A depicts an example in which the network is the training entity for an ML positioning model, and FIG. 7B depicts an example in which a training entity for an ML positioning model is distinct from the network, such as a third party entity or a UE manufacturer, UE vendor, or UE chip designer, as non-limiting examples.

Referring to FIG. 7A, a wireless communications system 700 includes UE 702, a TRP 704, and a server 710. In some implementations, wireless communications system 700 (or components thereof) includes or corresponds to wireless communications system 400 of FIG. 4 (or components thereof). For example, UE 702 may include or correspond to UE 115, TRP 704 may include or correspond to TRPs 430, and server 710 may include or correspond to training entity 440. In some implementations, server 710 is a server or other network component of a core network that communicates with UE 702 and TRP 704. Although communication links are shown in FIG. 7A between server 710 and UE 702, and between server 710 and TRP 704, such links may not be direct communication links. Instead, server 710 may communicate with one or more intermediate network entities, such as one or more base stations, that communicate directly with UE 702 or TRP 704. In the example shown in FIG. 7A, server 710 includes LMF 712, data collection manager 714, ML positioning model 716, and data repository 718. LMF 712, data collection manager 714, ML positioning model 716, and data repository 718 include or correspond to LMF 512, data collection manager 514, ML positioning model 516, and data repository 518 of FIG. 5A. Server 710 may send positioning configuration 720 to TRP 704 to configure TRP 704 to transmit PRSs 722, similar to as described with referent to FIGS. 5A-5B and 6A-6B.

Server 710 may configure UE 702 to participate in a process to gather training data for ML positioning model 716, which may involve UE 702 moving to one or more locations and measuring a received PRS to generate and provide a positioning measurement as well as providing information relating to UE clock drift from which simulated positioning measurements can be generated that represent the UE clock drift. For example, server 710 may send positioning/clock drift configuration 724 to UE 702. Positioning/clock drift configuration 724 may include configuration information that indicates or is associated with a positioning operation to be performed by UE 702, such as PRSs or SRSs associated with the positioning operation. Because UE 702 is being configured to provide additional simulated measurements, UE 702 may not be restricted to camping at any particular locations for any particular time periods as part of the process. In some implementations, positioning/clock drift configuration 724 may include or correspond to positioning configuration information 470 of FIG. 4. Additionally, positioning/clock drift configuration 724 may indicate a request for clock drift information.

Based on receiving positioning/clock drift configuration 724, UE 702 may monitor for PRSs 722 that are transmitted by TRP 704, and UE 702 may measure a CIR of a wireless communication channel between UE 702 and TRP 704 at a time that corresponds to receipt of one of PRSs 722. UE 702 may combine the CIR, an associated timestamp, and location information as positioning measurements 726 that are sent to server 710. UE 702 may also transmit clock drift information 728 to server 710, either separately or with positioning measurement 726. Clock drift information 728 may include one or more parameters that represent UE clock drift at UE 702, such as a median clock drift value, a mean clock drift value, a standard deviation clock drift value, a clock drift value at a given percentile, a polar range of clock drift values, a minimum clock drift value, a maximum clock drift value, a probability distribution associated with UE clock drift, instantaneous clock drift values, other parameters, or a combination thereof. In some implementations, portions of clock drift information 728 may correspond to particular operating temperatures or operating temperature ranges. Additionally, or alternatively, clock drift information 728 may indicate a group identifier of a group of UEs (e.g., a class or type of UEs, a UE manufacturer, etc.) for which clock drift information 728 is associated with, such that server 710 does not query other UEs of the group for respective clock drift information, thereby reducing signaling overhead in wireless communications system 700.

Server 710 may receive positioning measurements 726 and clock drift information 728, and server 710 may generate additional simulated positioning measurements (e.g., additional samples) by duplicating and combining positioning measurements 726 with simulated clock drift (e.g., artificial clock drift) based on clock drift information 728. For example, UE clock drift at UE 702 may be well-estimated or characterized in a lab setting or through other study or analysis, and clock drift information 728 may indicate various parameters that define the UE clock drift associated with UE 702. This information may be used to generate simulated CIRs that represent the variation in CIR measurements due to UE clock drift if multiple measurements were performed at the same location. As an illustrative example, UE 702 may perform a positioning operation related to PRSs 722 to record a CIR measurement f₀ at location (x₀, y₀, z₀). Server 710 may generate four simulated CIRs f₁, f₂, f₃, and f₄ based on clock drift information 728. In some implementations, an estimated CIR of a PRS with clock drift can be represented by Equation 1 described above with reference to FIG. 6A. In this example, the training data may include five CIRs: CIR f₀, CIR f₁ (with artificial clock drift \tilde{Δ}f₁), CIR f₂ (with artificial clock drift \tilde{Δ}f₂). CIR f₃ (with artificial clock drift \tilde{Δ}f₃), and CIR f₄ (with artificial clock drift Δf₄), each with label (x₀, y₀, z₀). Similar operations may be performed to gather training data that indicates CIRs at other locations, and the training data may be used to train ML positioning model 716 to receive an input CIR f₁ and to output either a predicted UE location (xᵢ, yᵢ, zᵢ) or intermediate positioning information (e.g., LOS, ToA, ToD, AoA, AOD, RSTD, RSRP, RSRPP, etc.). Because ML positioning model 716 is trained using training data derived from measurements and simulated measurements that represent UE clock drift for any given location, ML positioning model 716 may be trained to account for variations in CIR measurements due to clock drift at UE 702.

FIG. 7B depicts a wireless communications system 750 in which the training entity for an ML positioning model is a third-party or a vendor or programmer of a UE. In the example shown in FIG. 7B, wireless communications system 750 includes UE 702, TRP 704, server 710, and a training entity 752. Server 710 includes LMF 712, as described above with reference to FIG. 7A. Training entity 752 includes data collection manager 754, data repository 756, and ML positioning model 758. Data collection manager 754 may be configured to manage the collection of positioning data to be used as training data to train ML positioning model 758. For example, data collection manager 754 may receive data from UE 702 and manage and store the data at data repository 756 (e.g., a database or other storage location). ML positioning model 758 may include one or more ML models, such as NNs. SVMs, or other types of ML or AI models, that are trained to output a predicted location of a UE based on input positioning data from the UE. In some implementations, training entity 752 includes or corresponds to training entity 440 of FIG. 4, and ML positioning model 758 includes or corresponds to ML positioning model 442 of FIG. 4.

In the example shown in FIG. 7B, server 710 may provide positioning configuration 720 to TRP 704 and positioning/clock drift configuration 724 to UE 702 to configure UE 702 to perform one or more positioning operations to monitor for PRSs 722 from TRP 704, similar to as described above with reference to FIG. 7A. However, unlike in the example of FIG. 7A, in this example UE 702 sends positioning measurements 760 and clock drift information 762 to training entity 752, and training entity 752 generates the training data to train ML positioning model 758. As such, server 710 and LMF 712 may configure TRP 704 and UE 702 to perform operations on behalf of training entity 752. Similar to as described with reference to FIG. 7A, UE 702 may be free to move or be moved to any location at which UE 702 may perform a positioning operation to generate positioning measurements 760. After receiving positioning measurements 760 and clock drift information 762, training entity 752 may generate simulated positioning measurements based on simulated clock drift associated with UE 702, similar to as described above with reference to FIG. 7A. Because ML positioning model 758 is trained using training data derived from multiple CIRs (e.g., both measured and simulated) for any given location, ML positioning model 758 may be trained to account for variations in CIR measurements due to clock drift at UE 702.

FIG. 8 is a flow diagram illustrating an example process 800 that supports ML-based positioning that mitigates UE clock drift according to one or more aspects. Operations of process 800 may be performed by a UE, such as UE 115 described above with reference to FIGS. 1-4 or a UE described with reference to FIG. 6. For example, example operations (also referred to as “blocks”) of process 800 may enable UE 115 to support ML-based positioning that mitigates UE clock drift.

In block 802, the UE receives positioning configuration information from a network entity. For example, the positioning configuration information may include or correspond to the positioning configuration information 470 of FIG. 4. In some implementations, the positioning configuration information is included in positioning protocol assistance data message or a positioning broadcast message that is received from the network entity. In block 804, the UE performs, based on the positioning configuration information, one or more positioning operations with respect to one or more wireless communication channels. For example, the UE 115 of FIG. 4 may perform one or more positioning operations of wireless communication channels between the UE 115 and the TRPs 430 to receive the PRSs 480. In block 806, the UE transmits, to a training entity to enable training of an ML positioning model, one or more positioning measurements generated based on performance of the one or more positioning operations. For example, the one or more positioning measurements may include or correspond to the positioning measurements 482 of FIG. 4, and the ML positioning model may include or correspond to the ML positioning model 442 of FIG. 4.

In some implementations, the one or more positioning operations include monitoring for one or more PRSs from a TRP and measuring one or more CIRs of the one or more wireless communication channels associated with the one or more PRSs. For example, the one or more PRSs may include or correspond to PRSs 480 of FIG. 4, and the one or more CIRs may include or correspond to CIRs 406 of FIG. 4. In some such implementations, each of the one or more positioning measurements includes a CIR of the one or more CIRs and a timestamp associated with the measuring of the CIR. For example, the timestamps may include or correspond to timestamps 408 of FIG. 4. In some such implementations, each of the one or more positioning measurements further includes a location of the UE during the measuring of the CIR. For example, the location may include or correspond to locations 410 of FIG. 4.

In some implementations, the positioning configuration information indicates a quantity of one or more positioning occasions associated with positioning at the UE. For example, the quantity may include or correspond to quantity 472 of FIG. 4. In some such implementations, the one or more positioning operations are performed during the one or more positioning occasions while the UE remains at a fixed location during the one or more positioning occasions. In some other implementations, the positioning configuration information indicates a positioning duration associated with positioning at the UE. For example, the positioning duration may include or correspond to duration 474. In some such implementations, the one or more positioning operations are performed during the positioning duration while the UE remains at a fixed location during the positioning duration.

In some implementations, process 800 further includes transmitting positioning capability information to the network entity. The positioning capability information may indicate clock drift measuring capabilities of the UE. For example, the positioning capability information may include or correspond to positioning capability information 484. In some such implementations, the positioning capability information is transmitted during a positioning protocol capability exchange between the UE and the network entity.

In some implementations, the positioning configuration information includes an instruction to the UE to add simulated clock drift to reported positioning measurements. In some such implementations, performance of the one or more positioning operations generates initial positioning measurements, and process 800 further includes adjusting the initial positioning measurements based on simulated clock drift measurements to generate the one or more positioning measurements. For example, the simulated clock drift measurements may include or correspond to simulated clock drift measurements 412, which UE 115 may use to adjust one or more of CIRs 406 to generate positioning measurement 482 in some implementations. In some such implementations, the positioning configuration information indicates one or more clock drift parameters, and the simulated clock drift measurements are generated based on the one or more clock drift parameters. For example, the one or more clock drift parameters may include or correspond to clock drift parameters 476. Alternatively, the simulated clock drift measurements may be generated based on one or more clock drift parameters that are preprogrammed at the UE.

In some implementations, process 800 further includes transmitting positioning capability information to the network entity, and the positioning capability information indicates clock drift adjustment capabilities of the UE. For example, the positioning capability information may include or correspond to positioning capability information 484 of FIG. 4. In some such implementations, the positioning capability information is transmitted during a positioning protocol capability exchange between the UE and the network entity.

In some implementations, the positioning configuration information indicates a request for simulated clock drift information. For example, the request may include or correspond to request 478. In some such implementations, process 800 may also include transmitting, to the training entity to enable the training of the ML positioning model, the simulated clock drift information associated with the UE. For example, the simulated clock drift information may include or correspond to simulated clock drift information 488 of FIG. 4. In some such implementations, the simulated clock drift information is transmitted during a positioning protocol capability exchange between the UE and the network entity. Additionally or alternatively, the simulated clock drift information may includes a median UE clock drift, a mean UE clock drift, a standard deviation UE clock drift, a percentile UE clock drift, a UE clock drift range, a probability distribution associated with UE clock drift, or a combination thereof. Additionally or alternatively, the simulated clock drift information may include one or more clock drift estimates associated with the one or more positioning measurements. Additionally or alternatively, the simulated clock drift information may be transmitted in a reporting message that further includes an operating temperature range associated with the simulated clock drift information. For example, the reporting message may include or correspond to reporting message 486, and the operating temperature range may include or correspond to operating temperatures 490. Additionally or alternatively, the simulated clock drift information may be transmitted in a reporting message that further includes group information indicating a group of UEs associated with the simulated clock drift information. For example, the reporting message may include or correspond to reporting message 486, and the group information may include or correspond to UE group information 492.

FIG. 9 is a block diagram of an example UE 900 that supports ML-based positioning that mitigates UE clock drift according to one or more aspects. UE 900 may be configured to perform operations, including the blocks of a process described with reference to FIG. 8. In some implementations, UE 900 includes the structure, hardware, and components shown and described with reference to UE 115 of FIGS. 1-4, UE 502 of FIGS. 5A-5B, UE 602 of FIGS. 6A-6B, or UE 702 of FIGS. 7A-7B. For example, UE 900 includes controller 280, which operates to execute logic or computer instructions stored in memory 282, as well as controlling the components of UE 900 that provide the features and functionality of UE 900. UE 900, under control of controller 280, transmits and receives signals via wireless radios 901a-r and antennas 252a-r. Wireless radios 901a-r include various components and hardware, as illustrated in FIG. 2 for UE 115, including modulator and demodulators 254a-r, MIMO detector 256, receive processor 258, transmit processor 264, and TX MIMO processor 266.

As shown, memory 282 may include positioning configuration information 902, positioning measurements 903, and communication logic 904. Positioning configuration information 902 may include or correspond to positioning configuration information 470 of FIG. 4. Positioning measurements 903 may include or correspond to positioning measurement 482 of FIG. 4. Communication logic 904 may be configured to enable communication between UE 900 and one or more other devices. UE 900 may receive signals from or transmit signals to one or more network entities, such as base station 105 of FIGS. 1-3, network entity 450 of FIG. 4, server 510 of FIGS. 5A-5B, server 610 of FIGS. 6A-6B, or server 710 of FIGS. 7A-7B.

It is noted that one or more blocks (or operations) described with reference to FIG. 8 may be combined with one or more blocks (or operations) described with reference to another of the figures. For example, one or more blocks associated with FIG. 8 may be combined with one or more blocks (or operations) associated with FIGS. 1-4, 5A-5B, 6A-6B, or 7A-7B. Additionally, or alternatively, one or more operations described above with reference to FIGS. 1-4, 5A-5B, 6A-6B, or 7A-7B may be combined with one or more operations described with reference to FIG. 9.

In one or more aspects, techniques for supporting ML-based positioning that mitigates UE clock drift may include additional aspects, such as any single aspect or any combination of aspects described below or in connection with one or more other processes or devices described elsewhere herein. In some examples, the techniques one or more aspects may be implemented in a method or process. In some other examples, the techniques of one or more aspects may be implemented in a wireless communication device, such as a UE or a component of a UE. In some examples, the wireless communication device may include at least one processing unit or system (which may include an application processor, a modem or other components) and at least one memory device coupled to the processing unit. The processing unit or system may be configured to perform operations described herein with respect to the wireless communication device. In some examples, the memory device includes a non-transitory, computer-readable medium storing instructions or having program code stored thereon that, when executed by the processing unit or system, is configured to cause the wireless communication device to perform the operations described herein. Additionally, or alternatively, the wireless communication device may include an interface (e.g., a wireless communication interface) that includes a transmitter, a receiver, or a combination thereof. Additionally, or alternatively, the wireless communication device may include one or more means configured to perform operations described herein. In some other examples, the techniques of one or more aspects may be implemented in a network entity, such as a base station, a component of a base station, a server, a component of a server, another network entity, or a component of another network entity. In some examples, the network entity may include at least one processing unit or system (which may include an application processor, a modem or other components) and at least one memory device coupled to the processing unit. The processing unit or system may be configured to perform operations described herein with respect to the wireless communication device. In some examples, the memory device includes a non-transitory, computer-readable medium storing instructions or having program code stored thereon that, when executed by the processing unit or system, is configured to cause the network entity to perform the operations described herein. Additionally, or alternatively, the network entity may include an interface (e.g., a wireless communication interface) that includes a transmitter, a receiver, or a combination thereof. Additionally, or alternatively, the network entity may include one or more means configured to perform operations described herein.

Implementation examples are described in the following numbered clauses:

Clause 1: A method of wireless communication performed by a user equipment (UE), the method including: receiving positioning configuration information from a network entity; performing, based on the positioning configuration information, one or more positioning operations with respect to one or more wireless communication channels; and transmitting, to a training entity to enable training of a machine learning (ML) positioning model to account for UE clock drift, one or more positioning measurements generated based on performance of the one or more positioning operations.

Clause 2: The method of clause 1, where the one or more positioning operations include: monitoring for one or more positioning reference signals (PRSs) from a transmit/receive point (TRP); and measuring one or more channel impulse responses (CIRs) of the one or more wireless communication channels associated with the one or more PRSs.

Clause 3: The method of clause 2, where each of the one or more positioning measurements includes a CIR of the one or more CIRs and a timestamp associated with the measuring of the CIR.

Clause 4: The method of clause 3, where each of the one or more positioning measurements further includes a location of the UE during the measuring of the CIR.

Clause 5: The method of clause 1, where the positioning configuration information indicates a quantity of one or more positioning occasions associated with positioning at the UE.

Clause 6: The method of clause 5, where the one or more positioning operations are performed during the one or more positioning occasions while the UE remains at a fixed location during the one or more positioning occasions.

Clause 7: The method of clause 1, where the positioning configuration information indicates a positioning duration associated with positioning at the UE.

Clause 8: The method of clause 7, where the one or more positioning operations are performed during the positioning duration while the UE remains at a fixed location during the positioning duration.

Clause 9: The method of clause 1, further including transmitting positioning capability information to the network entity, where the positioning capability information indicates clock drift measuring capabilities of the UE.

Clause 10: The method of clause 9, where the positioning capability information is transmitted during a positioning protocol capability exchange between the UE and the network entity.

Clause 11: A user equipment (UE) configured for wireless communication, the UE including a memory storing processor-readable code and at least one processor coupled to the memory, the at least one processor configured to execute the processor-readable code to cause the at least one processor to: receive positioning configuration information from a network entity; perform, based on the positioning configuration information, one or more positioning operations with respect to one or more wireless communication channels; and transmit, to a training entity to enable training of a machine learning (ML) positioning model to account for UE clock drift, one or more positioning measurements generated based on performance of the one or more positioning operations.

Clause 12: The UE of clause 11, where the positioning configuration information includes an instruction to the UE to add simulated clock drift to reported positioning measurements.

Clause 13: The UE of clause 12, where performance of the one or more positioning operations generates initial positioning measurements, and where the at least one processor is further configured to, prior to transmission of the one or more positioning measurements, adjust the initial positioning measurements based on simulated clock drift measurements to generate the one or more positioning measurements.

Clause 14: The UE of clause 13, where the positioning configuration information indicates one or more clock drift parameters, and where the simulated clock drift measurements are generated based on the one or more clock drift parameters.

Clause 15: The UE of clause 13, where the simulated clock drift measurements are generated based on one or more clock drift parameters that are preprogrammed at the UE.

Clause 16: The UE of clause 11, where the at least one processor is further configured to transmit positioning capability information to the network entity, where the positioning capability information indicates clock drift adjustment capabilities of the UE.

Clause 17: The UE of clause 16, where the positioning capability information is transmitted during a positioning protocol capability exchange between the UE and the network entity.

Clause 18: The UE of clause 11, where the positioning configuration information is included in positioning protocol assistance data message or a positioning broadcast message that is received from the network entity.

Clause 19: A non-transitory, computer-readable medium storing instructions that, when executed by a processor of a user equipment (UE), causes the processor to perform operations including: receiving positioning configuration information from a network entity; performing, based on the positioning configuration information, one or more positioning operations with respect to one or more wireless communication channels; and transmitting, to a training entity to enable training of a machine learning (ML) positioning model to account for UE clock drift, one or more positioning measurements generated based on performance of the one or more positioning operations.

Clause 20: The non-transitory, computer-readable medium of clause 19, where the positioning configuration information indicates a request for simulated clock drift information.

Clause 21: The non-transitory, computer-readable medium of clause 20, where the operations further include transmitting, to the training entity to enable the training of the ML positioning model, the simulated clock drift information associated with the UE.

Clause 22: The non-transitory, computer-readable medium of clause 21, where the simulated clock drift information is transmitted during a positioning protocol capability exchange between the UE and the network entity.

Clause 23: The non-transitory, computer-readable medium of clause 21, where the simulated clock drift information includes a median UE clock drift, a mean UE clock drift, a standard deviation UE clock drift, a percentile UE clock drift, a UE clock drift range, a probability distribution associated with UE clock drift, or a combination thereof.

Clause 24: The non-transitory, computer-readable medium of clause 21, where the simulated clock drift information includes one or more clock drift estimates associated with the one or more positioning measurements.

Clause 25: The non-transitory, computer-readable medium of clause 21, where the simulated clock drift information is transmitted in a reporting message that further includes an operating temperature range associated with the simulated clock drift information.

Clause 26: The non-transitory, computer-readable medium of clause 21, where the simulated clock drift information is transmitted in a reporting message that further includes group information indicating a group of UEs associated with the simulated clock drift information.

Clause 27: An apparatus for wireless communication, the apparatus including: means for receiving positioning configuration information from a network entity; means for performing, based on the positioning configuration information, one or more positioning operations with respect to one or more wireless communication channels; and means for transmitting, to a training entity to enable training of a machine learning (ML) positioning model to account for clock drift, one or more positioning measurements generated based on performance of the one or more positioning operations.

Clause 28: The apparatus of clause 27, where the training entity includes a server associated with the network entity.

Clause 29: The apparatus of clause 27, where the training entity includes the network entity.

Clause 30: The apparatus of clause 27, where the training entity includes a server communicatively coupled to the apparatus.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-9 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of wireless communication performed by a user equipment (UE), the method comprising:
receiving positioning configuration information from a network entity;
performing, based on the positioning configuration information, one or more positioning operations with respect to one or more wireless communication channels; and
transmitting, to a training entity to enable training of a machine learning (ML) positioning model to account for UE clock drift, one or more positioning measurements generated based on performance of the one or more positioning operations.

2. The method of claim 1, wherein the one or more positioning operations comprise:
monitoring for one or more positioning reference signals (PRSs) from a transmit/receive point (TRP); and
measuring one or more channel impulse responses (CIRs) of the one or more wireless communication channels associated with the one or more PRSs.

3. The method of claim 2, wherein each of the one or more positioning measurements includes a CIR of the one or more CIRs and a timestamp associated with the measuring of the CIR.

4. The method of claim 3, wherein each of the one or more positioning measurements further includes a location of the UE during the measuring of the CIR.

5. The method of claim 1, wherein the positioning configuration information indicates a quantity of one or more positioning occasions associated with positioning at the UE.

6. The method of claim 5, wherein the one or more positioning operations are performed during the one or more positioning occasions while the UE remains at a fixed location during the one or more positioning occasions.

7. The method of claim 1, wherein the positioning configuration information indicates a positioning duration associated with positioning at the UE.

8. The method of claim 7, wherein the one or more positioning operations are performed during the positioning duration while the UE remains at a fixed location during the positioning duration.

9. The method of claim 1, further comprising:
transmitting positioning capability information to the network entity, wherein the positioning capability information indicates clock drift measuring capabilities of the UE.

10. The method of claim 9, wherein the positioning capability information is transmitted during a positioning protocol capability exchange between the UE and the network entity.

11. A user equipment (UE) configured for wireless communication, the UE comprising:
a memory storing processor-readable code; and
at least one processor coupled to the memory, the at least one processor configured to execute the processor-readable code to cause the at least one processor to:
receive positioning configuration information from a network entity;
perform, based on the positioning configuration information, one or more positioning operations with respect to one or more wireless communication channels; and
transmit, to a training entity to enable training of a machine learning (ML) positioning model to account for UE clock drift, one or more positioning measurements generated based on performance of the one or more positioning operations.

12. The UE of claim 11, wherein the positioning configuration information comprises an instruction to the UE to add simulated clock drift to reported positioning measurements.

13. The UE of claim 12, wherein performance of the one or more positioning operations generates initial positioning measurements, and wherein the at least one processor is further configured to, prior to transmission of the one or more positioning measurements:
adjust the initial positioning measurements based on simulated clock drift measurements to generate the one or more positioning measurements.

14. The UE of claim 13, wherein the positioning configuration information indicates one or more clock drift parameters, and wherein the simulated clock drift measurements are generated based on the one or more clock drift parameters.

15. The UE of claim 13, wherein the simulated clock drift measurements are generated based on one or more clock drift parameters that are preprogrammed at the UE.

16. The UE of claim 11, wherein the at least one processor is further configured to:
transmit positioning capability information to the network entity, wherein the positioning capability information indicates clock drift adjustment capabilities of the UE.

17. The UE of claim 16, wherein the positioning capability information is transmitted during a positioning protocol capability exchange between the UE and the network entity.

18. The UE of claim 11, wherein the positioning configuration information is included in positioning protocol assistance data message or a positioning broadcast message that is received from the network entity.

19. A non-transitory, computer-readable medium storing instructions that, when executed by a processor of a user equipment (UE), causes the processor to perform operations comprising:
receiving positioning configuration information from a network entity;
performing, based on the positioning configuration information, one or more positioning operations with respect to one or more wireless communication channels; and
transmitting, to a training entity to enable training of a machine learning (ML) positioning model to account for UE clock drift, one or more positioning measurements generated based on performance of the one or more positioning operations.

20. The non-transitory, computer-readable medium of claim 19, wherein the positioning configuration information indicates a request for simulated clock drift information.

21. The non-transitory, computer-readable medium of claim 20, wherein the operations further comprise:
transmitting, to the training entity to enable the training of the ML positioning model, the simulated clock drift information associated with the UE.

22. The non-transitory, computer-readable medium of claim 21, wherein the simulated clock drift information is transmitted during a positioning protocol capability exchange between the UE and the network entity.

23. The non-transitory, computer-readable medium of claim 21, wherein the simulated clock drift information includes a median UE clock drift, a mean UE clock drift, a standard deviation UE clock drift, a percentile UE clock drift, a UE clock drift range, a probability distribution associated with UE clock drift, or a combination thereof.

24. The non-transitory, computer-readable medium of claim 21, wherein the simulated clock drift information includes one or more clock drift estimates associated with the one or more positioning measurements.

25. The non-transitory, computer-readable medium of claim 21, wherein the simulated clock drift information is transmitted in a reporting message that further includes an operating temperature range associated with the simulated clock drift information.

26. The non-transitory, computer-readable medium of claim 21, wherein the simulated clock drift information is transmitted in a reporting message that further includes group information indicating a group of UEs associated with the simulated clock drift information.

27. An apparatus for wireless communication, the apparatus comprising:
means for receiving positioning configuration information from a network entity;
means for performing, based on the positioning configuration information, one or more positioning operations with respect to one or more wireless communication channels; and
means for transmitting, to a training entity to enable training of a machine learning (ML) positioning model to account for clock drift, one or more positioning measurements generated based on performance of the one or more positioning operations.

28. The apparatus of claim 27, wherein the training entity comprises a server associated with the network entity.

29. The apparatus of claim 27, wherein the training entity comprises the network entity.

30. The apparatus of claim 27, wherein the training entity comprises a server communicatively coupled to the apparatus.
